(19) United States
(12) Patent Application Publication
(10) Pub. No.: US 2026/0264332 A1
(43) Pub. Date: Sep. 10, 2026

(54) METHODS AND SYSTEMS FOR FABRICATING THREE-DIMENSIONAL OBJECTS BY ADDITIVE MANUFACTURING

(71) Applicant: University of Tasmania, Sandy Bay, Tasmania (AU)

(72) Inventors: Vipul Gupta, Sandy Bay, Tasmania (AU); Ahmad Reza Norouzi, Sandy Bay, Tasmania (AU)

(21) Appl. No.: 19/491,386

(22) PCT Filed: Jun. 10, 2024
(86) PCT No.: PCT/AU2024/050609

§ 371 Date: Dec. 8, 2025

(30) Foreign Application Priority Data
Jun. 9, 2023 (AU) 2023901844

(51) Int. Cl. B29C 64/336; B29C 64/129; B29C 64/209; B29K 83/00; B29K 105/00; B29K 509/02; B33Y 10/00; B33Y 30/00; B33Y 70/10

(52) U.S. Cl. CPC B29C 64/336; B29C 64/129; B29C 64/209; B33Y 10/00; B33Y 30/00; B33Y 70/10; B29K 2083/00; B29K 2105/0002; B29K 2509/02

(57) ABSTRACT

A hybrid Direct Ink Writing and photo-curing system and methods of using same, including a method for fabricating a three-dimensional object layer-by-layer upon a work surface using one or more photocurable inks, the work surface configured to be moveable relative to an ink deposition arrangement and a light source, the method comprising forming a layer of the three-dimensional object, said forming of a layer comprising: depositing photocurable ink; and selectively exposing the deposited ink to the light source, to thereby cure at least a portion of the deposited ink; the cured portion forming at least part of a layer of the three-dimensional object.

### REFERENCE TO EARLIER APPLICATION

The present application claims priority from Australian Provisional Patent Application No. 2023901844, the entire contents of which is incorporated herein by reference.

### TECHNICAL FIELD

This disclosure relates to methods and systems for fabricating three-dimensional objects, layer-by-layer.

### BACKGROUND ART

Additive manufacturing, or 3D printing, includes processes of fabricating 3D components progressively, in a layer-by-layer approach, using a range of different materials.

In one class of build materials, photo-curable inks or resins may be employed as the printing material. Such resins can be deposited in a flowable form, then exposed to light having a required wavelength (e.g. UV light) to cause polymerisation of the resin into a solid/consolidated form.

Vat photopolymerisation (or stereolithography) is a process wherein a component is fabricated by exposing a vat of resin to a photo-curing light, to selectively cure portions of the resin within the vat. The partially consolidated object is moved within the resin vat, to coat consolidated layers with fresh uncured resin, in preparation for subsequent polymerisation steps. Such vat processes are however limited to the use of a single resin in any given layer of the object. In addition, such vat processes require a significant excess of resin in the vat, relative to the resin required to form the part. The process may also be subject to difficulties in removing excess uncured material during the printing process (i.e. between curing of a given layer of the 3D component).

Vat polymerisation can also be limited to requiring low-viscosity resins (typically less than 10 Pa s) having low molecular weights, in order to facilitate recoating of the partially consolidated component with fresh, uncured material. This also imposes limitations upon the mechanical properties of the final printed component.

Direct Ink Writing (DIW) is an alternative additive manufacturing process, where portions of the material or ink for printing are deposited or extruded onto a surface in a spatially controlled manner, to fabricate layers of the consolidated 3D component. Typically, the entirety of a given deposited layer of ink is then exposed to a photocuring light, to thereby consolidate the deposited layer as part of the 3D object. Such processes are however limited to printing with relatively viscous inks, and suffer from limited shape resolution of the final component, due to spreading of the deposited ink prior to consolidation into a layer of the required 3D component. While deposition resolution can be, to some extent, improved by reducing the nozzle/extruder diameter of the deposition arrangement, small nozzle sizes can cause unacceptably low deposition rates and high print times, particularly given the relatively high viscosity inks required in conventional DIW processes.

Current 3D printers (e.g. stereolithography, digital light projection, and selective laser sintering/melting based printers) either do not offer multi-material printing, result in low-resolution printing (e.g. for many current fused deposition modelling and direct ink writing printers), or do not allow the use of custom inks (e.g. PolyJet printers). Currently, digital light projection (DLP)-based printers offer the highest resolution for 3D printing of macro-structures. DLP photo-curing can differ from other modes of photo-curing in that, rather than a light source (e.g. a laser) tracing the region to be cured, in DLP photo-curing, patterned light reflecting the cross-section to be cured is projected onto the material to be cured. By using projection optics, DLP can employ a digital mask to provide light in the desired pattern for the curing process. Recently, efforts have been made to modify these printers to obtain multi-material high-resolution 3D printing. However, the developed techniques involve a cumbersome approach of exchanging resin reservoirs and cleaning print surfaces, between printing of each layer, before printing of the following layer requiring a different print material. Moreover, current methods do not overcome the other limitations of the DLP-based printers, such as problems in using viscous inks and the difficulty in printing complex and/or heavy objects.

Accordingly, there is a need for improved or at least alternative methods for fabricating 3D objects.

It is to be understood that, if any prior art is referred to herein, such reference does not constitute an admission that the prior art forms a part of the common general knowledge in the art, in Australia or any other country.

### SUMMARY

The present invention relates to processes using a hybrid DIW and photo-curing system. Disclosed herein is a method for fabricating a three-dimensional object layer-by-layer upon a work surface using one or more photocurable inks, the work surface configured to be moveable relative to an ink deposition arrangement and a light source, the method comprising forming a layer of the three-dimensional object, said forming of a layer comprising: depositing photocurable ink; and selectively exposing the deposited ink to the light source, to thereby cure at least a portion of the deposited ink; the cured portion forming at least part of a layer of the three-dimensional object. In some embodiments, the photocurable ink has high oxygen resistivity.

In a first aspect, there is provided a method for fabricating a three-dimensional object layer-by-layer upon a work surface using two or more photocurable inks, the work surface configured to be moveable relative to an ink deposition arrangement and a light source, the method comprising forming a layer of the three-dimensional object, said forming of a layer comprising:
depositing a first photocurable ink;
selectively exposing the deposited first ink to the light source, to thereby cure at least a portion of the deposited first ink;
depositing a second photocurable ink; and
selectively exposing the deposited second ink to the light source, to thereby cure at least a portion of the deposited second ink;
wherein the cured portions of the first ink and the second ink form at least part of a layer of the three-dimensional object.

In the first aspect of the present invention, at least part of a layer of the three-dimensional object can be advantageously formed with cured portions of the first ink and the second ink. That is, through the use of a hybrid DIW and photo-curing system, plural materials can be deposited and cured for a layer of the fabricated part with suitable resolution. This can be contrasted to prior art photo-curing methods, such as vat polymerization, where multi-material printing requires the use of separate vats of resin in an alternating fashion such that each material is part of a separate layer, rather than there being adjacent portions of the two or more materials in the same layer. In vat polymerization, the need to swap between resin vats adds to manufacturing complexity, potential material waste through excess resin usage, and limits the parts that can be fabricated.

The first aspect of the present invention may provide greater flexibility and enable the product of more complex parts with plural materials. Furthermore, through the use of the hybrid DIW and photo-curing system, it may be possible to more readily print with plurals inks, while also minimizing ink usage (and associated waste) by using DIW for the initial ink deposition.

In addition to enabling fabrication of objects with layers including the cured portions of plural inks, the hybrid DIW and photo-curing may enable greater control over the depth of cure for each layer.

A second aspect provides a method for fabricating a three-dimensional object layer-by-layer upon a work surface using one or more photocurable inks, the work surface configured to be moveable relative to an ink deposition arrangement and a light source, the method comprising, for at least one layer of the three-dimensional object, forming said at least one layer such that said forming comprises:
depositing a photocurable ink to a first thickness, determined in a direction normal to a plane of the work surface; and
selectively exposing the deposited ink to the light source, to thereby cure at least a portion of the deposited first ink;
wherein the selective exposure of the deposited ink to the light source is configured such that said cured portion extends to a cured thickness, determined in a direction normal to a plane of the work surface, the cured thickness being less than or substantially equal to the deposited thickness.

Some embodiments of the second aspect are also in accordance with the first aspect. Thus, in some embodiments of the second aspect, the forming of a layer of the three-dimensional object further comprises:
depositing a second photocurable ink to a second thickness, determined in a direction normal to a plane of the work surface; and
selectively exposing the deposited second ink to the light source, to thereby cure at least a portion of the deposited second ink;
wherein the cured portions of the first ink and the second ink form at least part of a layer of the three-dimensional object and wherein the selective exposure of the deposited second ink to the light source is configured such that said cured portion of the second ink extends to a cured thickness, determined in a direction normal to a plane of the work surface, the cured thickness of the second ink being less than or substantially equal to the deposited thickness of the second ink.

The present invention also relates to a hybrid DIW and photo-curing system. Disclosed herein is a system for fabricating a three-dimensional object layer-by-layer using one or more photocurable inks, said system comprising: a work surface upon which the three-dimensional object is fabricated; an ink deposition arrangement configured for spatially controlled depositing of layers comprising one or more photocurable inks, each layer being in an initial ink deposition; and a light source configured for selectively exposing each initial ink deposition to light so that at least part of said initial ink deposition is photocured to provide a consolidated layer of the three-dimensional object; wherein the relative positioning of the work surface to the ink deposition arrangement and the light source is variable. The system may be configured to perform the methods of the first and/or second aspects. The system may be configured for fabricating the three-dimensional object using two or more photocurable inks, the cured portions of the two or more inks forming at least part of a layer of the three-dimensional object. In some embodiments, the system may comprise an ink removal arrangement configured for removing at least a portion of an uncured part of said initial ink deposition.

### DETAILED DESCRIPTION

As noted above, the present invention relates to processes using a hybrid DIW and photo-curing system, such as a system for fabricating a three-dimensional object layer-by-layer using one or more photocurable inks and comprising: a work surface upon which the three-dimensional object is fabricated; an ink deposition arrangement configured for spatially controlled depositing of layers comprising one or more photocurable inks onto the work surface, each layer being in an initial ink deposition; and a light source configured for selectively exposing each initial ink deposition to light so that at least part of said initial ink deposition is photocured to provide a consolidated layer of the three-dimensional object; wherein the relative positioning of the work surface to the ink deposition arrangement and the light source is variable. The DIW mechanism (e.g. the ink deposition arrangement) can be used to provide a “gross” spatial deposition (the initial deposition) of the photocurable ink(s), with the photo-curing mechanism (e.g. the light source) used to selectively cure the ink(s) so as to provide the final resolution of printed ink(s). That is, certain embodiments of the present invention relate to methods and systems for providing an initial disposition of an ink (or plural inks) at a first resolution and selectively curing the ink(s) to provide a final resolution that is more refined than the first resolution. The initial deposition may be deposited in a spatially-controlled manner, so as to provide a layer of ink in a geometry approximating the geometry of a layer of the three-dimensional object to be fabricated (i.e. at a first resolution of the layer). Depositing ink in a spatially-controlled manner can include depositing the ink in a predetermined printing pattern. As used herein, “predetermined printing pattern” refers to any type of printed pattern in accordance with a design that is determined prior to the initiation of printing. The pattern may be in many forms, depending on the component design. For example, it may be a regular geometric element in a regular layout, such as a uniform pattern, or a number of discrete (separate) elements with an interconnected unprinted zone, or interconnected print pattern elements with discrete unprinted areas. The predetermined printing pattern may be a suitably dimensionally precise pattern such that the ink is only deposited at intended locations and is not deposited at unintended locations, within an acceptable manufacturing tolerance. As appreciated by those in the art, manufacturing tolerances may be determined to achieve a desired mean and standard deviation of manufactured components in relation to the ideal component profile.

The initial deposition may be selectively photocured, so as to provide the final resolution, the final resolution being a refined resolution of the first resolution. This approach differs from some prior art processes, including vat polymerisation-type processes, where ink is either not deposited in a spatially controlled manner, or the ink deposition is allowed to coalesce to form a substantially homogeneous geometry after deposition, and prior to photocuring. Thus, there is disclosed a method for fabricating a three-dimensional object layer-by-layer upon a work surface using one or more photocurable inks, the work surface configured to be moveable relative to an ink deposition arrangement and a light source. The method comprises forming a layer of the three-dimensional object, said forming of a layer comprising: depositing photocurable ink; and selectively exposing the deposited ink to the light source, to thereby cure at least a portion of the deposited ink; the cured portion forming at least part of a layer of the three-dimensional object.

In a first aspect there is disclosed a method for fabricating a three-dimensional object layer-by-layer upon a work surface using two or more photocurable inks, the work surface configured to be moveable relative to an ink deposition arrangement and a light source. The method comprises forming a layer of the three-dimensional object, said forming of a layer comprising:
depositing a first photocurable ink;
selectively exposing the deposited first ink to the light source, to thereby cure at least a portion of the deposited first ink;
depositing a second photocurable ink; and
selectively exposing the deposited second ink to the light source, to thereby cure at least a portion of the deposited second ink;
   wherein the cured portions of the first ink and the second ink form at least part of a layer of the three-dimensional object.

The work surface or build platform is moveable relative to the ink deposition arrangement and light source, in x, y and z directions (i.e. three orthogonal axes), defining a three-dimensional, cartesian coordinate system. In some embodiments, the work surface is movable so as to change the relative position of the work surface and the ink deposition arrangement and light source. In some of these embodiments, one or both of the ink deposition arrangement and light source are also movable so as to further change the relative position of the work surface and the ink deposition arrangement and light source. The ink deposition arrangement and light source may be independently movable. In some other embodiments, the ink deposition arrangement and light source are each movable so as to change the relative position compared to a static work surface.

The work surface can be moved relative to the deposition arrangement and light source by means of actuators which can control the relative displacement of the work surface in the x, y and z directions, respectively. Generally, the work surface will be parallel to the x-y plane. The actuators can comprise electric stepper motors, timing belts and lead screws, though it should be appreciated that the actuators can be of any suitable type known in the art (e.g. electric, pneumatic, etc.).

The consolidation of two or more inks (i.e. build materials) into a single layer of the 3D component can advantageously allow multi-material components to be fabricated, in an efficient manner.

In some embodiments, said portion of the deposited first ink may be cured, prior to depositing the second ink. In some embodiments, after curing the said portion of the first ink, a remaining uncured portion of the first ink may be substantially removed, prior to depositing the second ink. As used herein, “substantially removed” includes the uncured portion being sufficiently removed so that fresh ink can be deposited and cured to provide a part with the desired geometry within acceptable manufacturing tolerances. In some cases, it can be acceptable for a residue or thin film of uncured material to remain, if the object will remain within dimension tolerances.

In some embodiments, each of the first and the second inks may be deposited, prior to photocuring/photopolymerising of either the first or second inks. In cases where each of the first and second inks are deposited prior to curing, the inks may be selected such that chemical reactions between the uncured inks (i.e. at interfaces between the first and second inks) are reduced, minimised or eliminated.

Alternatively or additionally, the inks may be selected to minimize interfacial mixing. In such embodiments, the inks may have low miscibility e.g. the inks may be immiscible. As such, the inks may be selected to have dissimilar polarity. The inks may be selected so that there is high interfacial tension between the inks. For example, first and second inks having dissimilar hydrophilicity may be selected, in order to minimise interfacial mixing between the deposited inks.

In other embodiments, interfacial mixing and/or reactions between the first and second inks may be desirable. Inks may be selected to provide a degree of chemical bonding at the interface of the inks. In some other embodiments, the inks may be partially miscible to promote physical binding at the interface (e.g. to promote a degree of mechanical interlocking in the consolidated layer comprising the first and second inks). In some such embodiments, inks having similar or substantially identical polarity may be selected, which may serve to promote interfacial mixing of the deposited inks prior to photocuring. In some embodiments, a single-phase region (a miscible polymer blend) may form at the interface due to interfacial mixing. In some embodiments, a two-phase region may form at the interface of the inks as a blend of the inks is formed by interfacial mixing.

In some embodiments, the deposition of the first ink may act as a template for the deposition of subsequent inks, although the cured portions of both inks will form part of the fabricated three-dimensional object. In such embodiments, the first ink may be of a higher viscosity than the second ink for example, such that the deposited second ink may be contained within regions of the first deposited ink (i.e. the second deposited ink may, in a spatially-controlled manner, infill areas bounded by the deposition of the first ink). In some embodiments, the deposited first ink may be cured prior to deposition of the second ink, such that the cured first ink acts as a consolidated template or support, which may be selectively infilled by the second ink, prior to curing of the second ink to form a consolidated layer of the 3D component.

In further embodiments, the surface onto which the inks are deposited (i.e. the work surface or a consolidated layer of the 3D component) may be functionalised such that subsequently deposited ink can interact more favourably with the functionalised regions, than the non-functionalised regions. For example, such functionalisation may act to minimise spreading of the deposited ink, e.g. by selectively initiating curing of the deposited ink, which may aid in retention of a first resolution of an initial deposition of the ink, prior to photocuring. The surface may be functionalised so that the contact angle and wettability of the ink is within a desirable range. For example, promoting a higher contact angle (and lower wettability) may assist in spatially controlling deposition. In some embodiments, the surface may be made relatively more hydrophilic or oleophilic, which may be advantageous for the use of water- or oil-based inks (e.g. water- or oil-based resins), respectively. In some embodiments, the surface may be functionalised with functional groups that may conjugate with surface groups available in the resin. For example, vinyl groups may be used to conjugate with thiol and acrylate resins in some embodiments. In some embodiments, the surface may be thiol-functionalised (i.e. functionalised with thiol groups) before an acrylate-based resin is deposited on the surface. Such functionalisation may advantageously promote curing of a portion of the deposited ink at the surface, contributing to enhanced adherence of the ink layer to the surface. This may in turn limit spreading of the deposited ink layer, prior to photocuring of the layer.

In some embodiments, the surface may be locally heated or cooled. In some embodiments, heating may be used to lead to curing of certain inks (e.g. certain resins) or to control curing times. In some embodiments, cooling may be used to increase the viscosity of certain inks (e.g. certain resins) or to control curing times. Temperature may also affect the miscibility of the inks.

In some embodiments, the ink deposition arrangement may be used to deposit alternative materials that are not necessarily photocurable. Such materials can act as guides or templates for the photocurable inks, and/or as support materials i.e. to form structures for supporting the 3D printed object during fabrication, particularly in the fabrication of 3D parts having complex and or overhanging geometries. In some embodiments, such supporting structures do not form part of the 3D component itself (i.e. are not consolidated within a layer of the component) and may be removed after fabrication of the 3D component is complete. The support material can be of any suitable type known in the art, allowing supporting structures made therefrom to be selectively removed from the desired 3D object after the print is completed. The support material can either be solidified upon deposition or used as it is, depending upon its rheology and ability to retain its shape. Solidification of the support material may be achieved by thermal-, photo-, chemical-, or other forms of polymerisation or densification. For example, wax can be extruded as a hot liquid, followed by its solidification upon cooling. Alternatively, high-viscosity materials, such as viscous slurries can act as supports when in the same state as they are deposited, if they can sufficiently support the overlaying layers of deposited inks. The support materials can be physically or chemically removed from the printed object. For example, support structures can be initially broken, peeled, or scrubbed from the built object, followed by dissolution or dispersion in a suitable solvent of any remaining support material. For example, after physical removal, wax can be washed-off in hot oil, and slurries can be dissolved in an appropriate solvent.

In some embodiments, after curing the said portion of the second ink, a remaining uncured portion of the second ink may be substantially removed.

In some embodiments, the deposition arrangement may be positioned at a first height above the work surface during deposition of the first ink, and the deposition arrangement may be positioned at a second height above the work surface during deposition of the second ink. The height or distance between the ink deposition arrangement and the work surface can be varied to obtain different thicknesses of extruded ink for example. One of skill in the art will appreciate that the optimum height for deposition of a particular material will also depend upon the viscosity of the material to be deposited and the temperature of the material and/or work surface, which can modify the rheological properties of the material. If too small a height (i.e. gap between the work surface and ink deposition arrangement) is selected for a particular ink, the continuous flow of ink from the ink deposition arrangement (as deposited through a nozzle for example), may be interrupted. In general, the minimum suitable gap between the ink deposition arrangement and the work surface will increase with increasing ink viscosity.

If on the other hand too large a height above the work surface is selected, the resolution of the deposited ink (i.e. the ability to conform the deposited ink to a particular geometry or pattern on the work surface) may be limited, for example due to unwanted lateral spreading of the deposited ink, prior to curing. In general, the maximum suitable gap between the ink deposition arrangement and the work surface will decrease with decreasing ink viscosity.

The deposition height may therefore be selected in order to control or limit spreading of the uncured material in the x-y plane over the work surface, to achieve a required deposition shape and thickness of a given deposited layer, prior to consolidation into a cured layer of the 3D object.

In some embodiments, each of the first height and the second height may be selected from a range of about 20 μm to about 1 mm. In some embodiments, each of the first height and the second height may be selected from a range of about 100 μm to about 400 μm.

In some embodiments, the first height may be approximately the same as the second height.

In some embodiments, wherein the ink deposition arrangement comprises two or more ink dispensers, each of the two or more ink dispensers may be configured for dispensing a respective ink.

In some embodiments, each of the ink dispensers may comprise one of a syringe, inkjet head or other form of extruder. Syringes may be preferred for the dispensing of relatively high viscosity inks, while inkjet heads may be preferred for the dispensing of relatively low viscosity inks. Where inkjet heads are employed, low viscosity inks may be ‘jetted’ at elevated temperatures (further reducing viscosity) in order to deposit the inks, provided the inks possess sufficient thermal stability, as will be appreciated by those of skill in the art. In such embodiments, the work surface or cured layer upon which the ink is to be jetted may be held at a lower temperature (e.g. ambient temperature or cooled below ambient) in order to increase the viscosity of the ink after deposition, improving shape retention of the deposited ink pattern (i.e. prior to curing).

For inks of higher viscosity and/or lower thermal stability, syringe deposition may be preferable.

In some embodiments, the ink dispenser may comprise one or more pistons or pumps, which may be driven electrically, pneumatically, etc. For example, where syringes are employed, they are typically mechanically actuated, such as having an extrusion motor or other mechanism to depress a piston of the syringe to achieve a desired rate of extrusion of the material. In some embodiments, the ink deposition arrangement may be fed manually.

In some embodiments the ink dispensers may be provided with nozzles through which said inks may be deposited/extruded. Such nozzles may have any suitable diameter e.g. from about 100 μm to 1000 μm. Those of skill in the art will readily appreciate that suitable nozzle diameter will be selected with reference to the ink or material to be deposited, the complexity of the part to be fabricated and with particular regard to the rheological properties of the material to be deposited. For example, for more viscous inks a larger nozzle diameter may be preferred in order to reduce the required deposition time (i.e. increase the deposition rate by allowing a larger volume of material to be deposited through the nozzle). Where inks of lower viscosities are employed, smaller diameter nozzles may be used to decrease the rate of ink deposition and reduce spreading of the ink on the work surface or the workpiece onto which fresh ink is being deposited, prior to consolidation by photopolymerisation. Deposition pressure may also be modulated, in tandem with nozzle diameter and ink rheology, in order to optimise ink deposition. For example, the combination of larger diameter nozzles and higher extrusion forces can be preferable for the deposition of higher-viscosity resins and vice versa.

Suitable nozzle diameter can also be selected with regard to the size of the features of the 3D part to be manufactured, with smaller nozzle sizes preferred for finer parts or more intricate features within a given deposition layer.

One of skill in the art will appreciate that the preferred viscosity for a given ink will depend upon a range of factors, including the type of deposition arrangement employed. For example, where syringes are employed for depositing inks, preferred ink viscosity may range from approximately 0.1 Pa·s to 1000 Pa·s. In some embodiments, preferred ink viscosity may range up to 7000 Pa·s. In some embodiments, print heads such as the ‘vipro-HEAD’ series supplied by ViscoTec Pumpen (Töging am Inn, Germany), may be suitable for ink deposition.

It should be understood that suitable ink viscosity is not, however, limited to the above ranges. In some embodiments, suitably ink viscosity may range from 0.01 Pa·s to 60 000 Pa·s. One of skill in the art will appreciate that various ink deposition arrangements may be employed in order to accommodate a given ink viscosity.

Nozzle/extruder geometries may be of any type known in the art. For example, suitable cross-sectional geometries for the nozzle or extruder orifice may comprise shapes including generally circular, elliptical, stadium-shaped, rectangular, or triangular-type cross-sections, etc.

Orifice shape or cross-section can dictate the required extrusion pressure for the resin, as well as the shape and the resolution of the extruded lines of resin that can be deposited by the deposition arrangement. For example, a nozzle having a generally stadium-shaped cross-section may allow for the deposition of less thick layers (i.e. in the Z-direction), than could be achieved with a nozzle having a circular or rectangular cross-section.

In some embodiments, the forming of a layer of the three-dimensional object may comprise moving the work surface relative to the ink deposition arrangement, the ink deposition arrangement can selectively actuate one or more of the ink dispensers at different relative positions of the work surface and ink deposition arrangement, to thereby deposit the one or more inks at said positions.

In some embodiments, photocurable inks employed by the method may exhibit a high oxygen resistance. It will be appreciated by those of skill in the art, that spatially controlled ink deposition may result in a relatively large surface area of the deposited ink being exposed to the surrounding atmosphere. This may preclude inks susceptible to attack by oxygen from being employed in the hybrid DIW and photo-curing system of the present invention, unless fabrication is performed in a substantially oxygen free atmosphere. Such ink may be those typically limited to application in vat polymerisation processes, where a relatively smaller surface area of uncured ink is exposed to the atmosphere during the fabrication process.

Molecular oxygen is known to inhibit a range of photopolymerisation reactions, acting to decrease the curing rate of photocurable inks. An ink possessing a relatively high oxygen resistance will exhibit a higher curing rate than an ink possessing a relatively low oxygen resistance, all else being equal. For photocurable inks deposited in the presence of oxygen, particularly those employed for DIW depositions having relatively large exposed-surface areas, high oxygen resistance may be particularly advantageous. Inks having a higher oxygen resistance may be less susceptible to oxygen inhibition than inks having a lower oxygen resistance, when the inks are deposited and photocured in the presence of oxygen (i.e. in air, instead of under an inert atmosphere such as nitrogen).

High oxygen resistance of an ink may, in some embodiments, permit faster curing rates. In some embodiments, high oxygen resistance may permit substantially complete or full curing of portions of the ink exposed to a pattern of photocuring light, resulting in a high level of correspondence between the pattern of light and the geometry of the cured ink. This may allow for improved resolution control during curing of layers of the component to be fabricated and permit efficient photocuring of relatively intricate, spatially-controlled ink depositions. In contrast, inks having relatively low oxygen resistance may not permit substantially complete curing of portions of ink corresponding to the applied pattern of photocuring light. This may result in reduced resolution of cured layers of the component, and prevent effective photocuring of intricate, spatially-controlled ink depositions.

The curing rate or polymerisation rate of a given photocurable ink in the presence of oxygen may depend upon the tendency of the ink to polymerise under given photocuring conditions, for example, when the ink is exposed to a photocuring light having a particular wavelength and intensity, for a given time. One of skill in the art will appreciate that a number of parameters may impact the curing rate for a given ink composition (e.g. including deposition volume, thickness and surface area, curing temperature, photocuring light wavelength and intensity, etc.). To compare the curing rate (and by extension, assess the oxygen resistance) of inks having differing compositions, standardised curing conditions may be employed.

A technique for assessing oxygen resistance may comprise assessing the curing rate of the ink. One method of assessing polymerisation rate is to observe monomer to polymer conversion over time, for example, by employing the techniques described in O'Brien et. al. Oxygen inhibition in thiol-acrylate photopolymerizations, Journal of Polymer Science Part A: Polymer Chemistry. 44. 2007-2014, 10.1002/pola.21304 (O'Brien), the contents of which are incorporated by reference herein, in their entirety. Fourier Transform Infrared (FTIR) spectroscopy (e.g. a Nicolet Model 760 Magna Series II FTIR, Nicolet, Madison, WI) can be used to assess the extent of polymerisation and to examine the polymerisation kinetics for photocurable inks. A horizontal transmission apparatus (HTA) accessory is used to enable mounting of the samples in a horizontal orientation for FTIR measurements. Ink samples can be placed on NaCl crystals and rolled to a uniform thickness (such as a thickness of 12 μm using wire-wound rods (e.g. Gardco, Pompano Beach, FL)). Samples not to be exposed to oxygen are laminated with a second NaCl crystal and placed into the HTA, while the unlaminated samples (i.e. samples to be exposed to oxygen) are placed in the HTA and allowed to equilibrate with the ambient environment for 15 minutes. The polymerisation reaction is initiated using a suitable UV-light source (e.g. a high pressure 100-watt mercury vapor short arc UV light source equipped with a liquid light guide and band-pass filter (320-390 nm)). The polymerisation rates for the two sample types can then be compared to assess the effect of oxygen on polymerisation.

For acrylate and thiol-containing inks, monomer conversion can be determined from the change in absorbance of the acrylate [C═C] double bond peak and the thiol S—H peak observed, respectively. The polymerisation rate can be calculated from the first derivative of the monomer conversions with respect to time (dX/dt) divided by the initial monomer concentration. In the mid-IR range, the acrylate peak may be at 1604-1648 cm⁻¹ and the thiol peak may be at 2609-2514 cm⁻¹. Similar FTIR measurements can be employed to assess monomer conversion for other ink systems based on monitoring the characteristic FTIR peaks of the reactive groups for polymerisation.

Further methods are described in Publication No. US 2021/0088900 A1, the contents of which are incorporated by reference herein, in their entirety. As outlined above, the curing or polymerisation rate of an ink may be used as an assessment means of oxygen resistance for the ink.

In accordance with the methodology as described in O'Brien, the ratio of polymerization rate in the presence of oxygen (R_{pO2}) to polymerization rate in the absence of oxygen (P_{p Lam}), may be used to assess oxygen resistance. The assessment may be based on the proposed curing conditions or a nominal benchmark curing condition, such as that described in the ‘Methods’ of O'Brien. As defined herein, when assessed in this way, an ink having a high oxygen resistance may include, but is not limited to, an ink having:
a R_{pO2}/P_{p Lam} ratio of at least 0.1, such as greater than 0.2, greater than 0.5 or greater than 0.6.

It will be appreciated that the higher the R_{pO2}/P_{p Lam} ratio, the higher the oxygen resistance of the ink. A R_{pO2}/P_{p Lam} ratio of 1 is indicative of the ink exhibiting the same polymerisation rate in the presence of oxygen as that exhibited in the absence of oxygen, under the conditions set forth in O'Brien.

In some embodiments of the present invention, it may be sufficient to employ one or more photocurable inks having an oxygen resistance such that the R_{pO2}/P_{p Lam} ratio of the ink is at least 0.005. It will be appreciated that for embodiments in which fabrication is performed in an oxygen-containing atmosphere, employing inks with higher oxygen resistivities can be advantageous.

In some preferred embodiments, the photocurable ink (or at least one of the inks, when more than one is used) selected will have a R_{pO2}/P_{p Lam} ratio of at least 0.8.

In a particularly preferred embodiment, the photocurable ink (or at least one of the inks, when more than one is used) selected will have a R_{pO2}/P_{p Lam} ratio of 1.

Alternative techniques may also be employed to assess oxygen resistance, such as determining the extent of polymerisation of a given volume or depth of ink (i.e. fraction or percentage of conversion of monomer to polymer, with 100% polymerisation representing substantially complete conversion or ‘full’ polymerisation or curing) for a given duration of photocuring light application. One of skill in the art will appreciate that the percentage of polymerisation for a given ink under given curing conditions, will also depend upon the depth of the ink being exposed to the photocuring light. Portions of the ink near the outer surface or ‘top’ of an ink deposition will, by virtue of greater exposure to surrounding oxygen, exhibit lower curing rates than portions of ink near the centre or ‘bottom’ of the ink deposition. In other words, the depth (i.e. distance from a surface exposed to oxygen) at which percentage polymerisation is determined should also be specified, in order to meaningfully compare the curing rate and oxygen resistance of different inks.

An alternative technique for assessing oxygen resistance may therefore comprise measuring the percentage polymerisation of a given depth of an ink deposition, after exposure to photocuring light for a given time.

To determine the percentage polymerisation for an ink, deposition of a controlled volume and geometry of ink should be provided in the presence of oxygen (e.g. air). In one assessment methodology, the assessment may be based on the proposed curing conditions or a nominal benchmark curing condition. As defined herein, when assessed in this way, an ink having a high oxygen resistance may include, but is not limited to, an ink having:
a percentage polymerisation of at least 80%, after being subjected to the curing conditions.

As an example of an assessment methodology that can be based on the proposed curing conditions or a nominal benchmark curing condition, a real-time Fourier-transform infrared (RT-FTIR) spectroscopy method can be employed to study the photo-polymerisation reaction kinetics. Single Infrared spectra may be acquired on a Bruker Vertex 70 Fourier transform infrared (FTIR) spectrometer using a single reflection Diamond ATR (Bruker Platinum) in the range of 3800-550 cm⁻¹ with a spectral resolution of 4 cm⁻¹. A volume of 5 μL of ink can be pipetted onto the diamond ATR and 32 scans used for the sample measurements as well as background. The spectral resolution can be set to 8 cm⁻¹ and the scanner velocity set to 160 kHz with a single sided acquisition mode. This can result in an acquisition rate of 17.6 spectra per second by recording only the interferograms, for the duration of 10,000 acquisitions, approximately 9.45 minutes, per kinetic run. The kinetic run may be started manually just prior to turning on the UV LED (photopolymerising light source) which is placed above the Diamond crystal. Furthermore, a monochromatic UV LED with a 3 mm focusing lens (with λₘₐₓ=405 nm and intensity of 20 mW/cm²) (Digi-Key electronics) can be used for irradiating all samples, for approximately 9.45 minutes each. A basic electrical circuit can be employed to power the LED, while monitoring the current to prevent any damage. An LED cover is provided to align the LED with the sample and to avoid samples being exposed to ambient light. The LED is positioned 3 mm above the ATR stage.

The samples are exposed to the air during monitoring of the polymerisation reaction to assess the impact of oxygen inhibition on the photo-polymerisation kinetics. Assessments using this method are performed at 21° C. and under atmospheric conditions.

Post processing can involve splitting the interferograms and creating spectra from the interferograms using the OPUS software (Version 8.1). The spectra are then integrated at the specified wavenumbers to plot peak area or intensity versus time.

The —CH═CH₂ bending and stretching peaks at ~ 939 cm⁻¹ and ~1637 cm⁻¹ are monitored to calculate the gelation time and percentage polymerisation, respectively. To assess thiol conversion (for inks containing thiol), the height of the —CH═CH₂ bending peak centred at 939 cm⁻¹ can be monitored over time as per Equation (1), where Xₜ is thiol conversion at time (t), A₀ is the initial absorbance, and Aₜ is the absorbance at the time (t). One of skill in the art will appreciate that corresponding assessment criteria may be applied to assess inks of differing composition.

$${X}_{t} = \frac{{A}_{θ} - {A}_{t}}{{A}_{0}} \qquad Equation ( 1 )$$

The peak area at ~1637 cm⁻¹ in the range of 1650-1620 cm⁻¹ can be integrated at a subsequent time (t), and the percentage of polymerisation (%) at that time was calculated as per Equation (2):

$${P}_{t} = \frac{{A}_{0} - {A}_{t}}{{A}_{θ}} * 100 \qquad Equation ( 2 )$$

where Pₜ is the percentage polymerisation at time (t), A₀ is the initial absorbance, and Aₜ is the absorbance at the time (t).

A further alternative method of assessing oxygen resistance may comprise measuring the depth to which the photocured ink exhibits a particular minimum percentage polymerisation (e.g. 80% polymerisation) after a given photocuring time. Such a depth may be defined as an ‘assessment depth of cure’ and may be measured in a direction normal to a plane of the work surface onto which the ink is deposited. The measurement and specifying of curing depth can be misleading however, as a determine cured depth may embrace portions of the deposition that are cured to differing degrees (i.e. having differing degrees of polymerisation). For example, a determined cure depth may embrace both fully polymerised, ‘solid’ portions (100% polymerisation) and partially polymerised portions, in the form of a gel. This may lead to a misleading assessment of oxygen resistance.

In actual fabrication of three-dimensional objects layer-by-layer, the term ‘depth of cure’ (or curing depth) may relate to substantially full polymerisation, through the thickness of a given ink deposition to form a solid layer, or may also embrace varying degrees of partial curing or gelation within the given thickness or depth of cure such that the ink is converted to a non-flowable material. In some embodiments, a depth of cure comprising substantially full polymerisation (substantially 100% conversion of monomer to polymer) may be advantageous for some or all layers. In some further embodiments, a depth of cure comprising partial polymerisation (i.e. less than 100% conversion of monomer to polymer) may be advantageous. In some embodiments, selectively exposing the deposited ink to the light source, to thereby cure at least a portion of the deposited ink, may include curing portions of the deposited ink(s) so that parts of each ink have the same depth of cure but differing degrees of polymerization. In yet other embodiments, selectively exposing the deposited ink to the light source, to thereby cure at least a portion of the deposited ink, may include curing portions of the deposited ink(s) so that parts of each ink have differing depths of cure. Curing parameters may be selected to provide the desired depth of cure and/or degree of polymerisation based on the intended use of the three-dimensional object.

Typically, the curing conditions will be selected to provide a depth of cure that affords suitable dimensional stability to the workpiece and the final, fabricated three-dimensional object. As noted above, the cured material can include solid portions and gelled portions. The gelled portion may be of suitable dimensional stability that subsequent layers of ink can be deposited on top as part of the fabrication process.

In some embodiments, following fabrication of the three-dimensional object layer-by-layer, the three-dimensional object may be subjected to post-processing. In some embodiments, post-processing may comprise a further curing process, which may advantageously impart improved strength to the three-dimensional object. That is, the post-processing process may increase the degree of polymerisation in the object. This may include converting gelled portions into solid polymer portions.

In some embodiments, the further curing process may comprise non-selective (i.e. ‘gross’) curing of the three-dimensional object. Such non-selective curing may embrace curing by high-intensity photocuring light. In some embodiments, the further curing process may comprise exposing the three-dimensional object to elevated temperatures. For example, elevated temperatures may be employed when the inks are capable of thermally initiated curing, as well as photo-curing.

In some embodiments, post-processing may comprise a cleaning process, for example to remove portions of uncured ink, prior to further curing.

The term ‘depth of cure’, as used in reference to the fabrication of three-dimensional objects, may be distinct from the term ‘assessment depth of cure’, as defined herein.

As an example of an assessment methodology for determining assessment depth of cure, that can be based on the proposed curing conditions or a nominal benchmark curing condition, curing depth is determined by depositing approximately 160 μL of ink into a cylindrical mould, having an internal diameter of 10 mm and a height of 2 mm. The deposited ink is then exposed to photocuring light of given wavelength and intensity, within approximately 60 seconds of deposition, for an exposure time of 300 seconds, with both deposition and curing conducted at a given temperature. The assessment curing depth is measured using a micrometre.

As an example of a particular, suitable benchmark assessment methodology for determining assessment depth of cure, the inks described in the present disclosure may be assessed for oxygen resistance by depositing and curing the inks at a temperature of approximately 20° C., in the presence of air. Approximately 160 μL of ink is deposited into a cylindrical mould having an internal diameter of 10 mm and a height of 2 mm. The mould is sprayed with a Teflon spray prior to deposition of the ink, to minimise adhesion. Within approximately 60 seconds of ink deposition, the ink is exposed to photocuring light of 405 nm wavelength, for 300 seconds. The assessment curing depth is measured using a micrometre.

Those of skill in the art will appreciate that the foregoing methods of oxygen resistance assessment may be varied, provided that the particular techniques used are specified.

Oxygen inhibition of photopolymerisation reactions in various systems, including acrylate-based monomer systems, can result in a reduction in polymerisation efficiency during photocuring. Such oxygen inhibition may, in some cases, prevent full curing (i.e. substantially complete full-thickness curing) of deposited inks. Portions of ink having greater oxygen exposure (e.g. the outer, exposed surfaces of an ink deposition), may absorb sufficient oxygen to prevent full curing. For this reason, full-thickness curing of a deposited layer of an oxygen-susceptible ink may be prevented, reducing the maximum resolution obtainable in subsequent selective photocuring of the deposition.

This may be particularly problematic for spatially-controlled ink depositions, where relatively large surface areas of the deposited ink may be exposed to the surrounding atmosphere. In some cases, spatially-controlled depositions having finely separated geometric features with large surface areas (i.e. intended to approximate the geometric features of a layer of the object to be fabricated) may not be able to be successfully photocured if the deposited ink is not sufficiently resistant to oxygen inhibition. In particular, inks having high oxygen resistance may permit the use of more finely controlled selective photocuring light (e.g. use of high-resolution patterns of light, better approximating the geometry of the layer of the part to be cured), as such inks may allow for full or near 100% polymerisation of the portions of ink exposed to the light. In other words, such inks may permit better correspondence between the geometry of the applied light and that of the corresponding cured layer, resulting in a more refined cured resolution.

Inks highly susceptible to oxygen inhibition, e.g. acrylate-based inks lacking thiol content, are typically restricted to vat-type deposition processes, where exposure to oxygen can be reduced.

In some embodiments, the photocurable ink(s) (e.g. in the first aspect of the invention each of two or more photocurable inks) may comprise a precursor of a material for forming a polymer. Forming the polymer may comprise one or more of:
reacting a reactive thiol group of the ink with an ene compound of the ink, comprising one or more reactive ene groups, under conditions that promote a thiol-ene reaction;
reacting a reactive thiol group of the ink with an yne compound of the ink, comprising one or more reactive yne groups, under conditions that promote a thiol-yne reaction;
reacting a reactive thiol group of the ink with an acrylate compound of the ink, comprising one or more reactive acrylate groups, under conditions that promote a thiol-acrylate reaction.

The thiol content in photopolymers as commonly observed in thiol-ene-, thiol-acrylate-, and thiol-yne-based resins is known to confer improved oxygen resistance (e.g. see O'Brien), which may allow such resins to be successfully deposited in ambient conditions (i.e. not requiring an inert atmosphere for printing). Such inks can provide considerable advantages over prior art inks which have greater susceptibility to inhibition by oxygen, such as acrylate-based inks, particularly in DIW applications where spatially-controlled deposition may advantageously provide a first resolution approximating the geometry of a layer of the three-dimensional object to be fabricated. As described above however, such spatially-controlled depositions will present much larger surface areas of deposited ink to the surrounding environment, than is the case for traditional vat-based processes.

In some embodiments, the ink may comprise a molar ratio of reactive thiol groups to complementary reactive groups of the ink of 0.1:1 to 1:1. The complementary reactive group may be an acrylate group, ene group or yne group, depending on whether a thiol-acrylate-, thiol-ene-, or thiol-yne-based resin system is selected for the ink. Such inks may have high oxygen resistivity.

As described in O'Brien, oxygen inhibition of photopolymerisation reactions in various acrylate-based monomer systems (i.e. those not containing thiol or having insufficient thiol) can result in a reduction in polymerisation efficiency during photocuring. Such oxygen inhibition may, in many cases, prevent full curing (i.e. substantially complete full-thickness curing) of deposited inks. Portions of ink having greater oxygen exposure (e.g. the outer, exposed surfaces of an ink deposition), may absorb sufficient oxygen to prevent full curing. For this reason, full-thickness curing of a deposited layer of an oxygen-susceptible ink may be prevented, reducing the maximum resolution obtainable in subsequent selective photocuring of the deposition. This may be particularly problematic for spatially-controlled ink depositions, where relatively large surface areas of the deposited ink may be exposed to the surrounding atmosphere. In some cases, spatially-controlled depositions having finely separated geometric features with large surface areas (i.e. intended to approximate the geometric features of a layer of the object to be fabricated) may not be able to be successfully photocured if the deposited ink is not sufficiently resistant to oxygen inhibition. Inks highly susceptible to oxygen inhibition, e.g. acrylate inks lacking thiol-groups, are typically restricted to vat-type deposition processes, where exposure to oxygen can be reduced.

Without wishing to be bound by any particular theory, it is believed that molecular oxygen may act as a scavenger for radicals or reactive species which participate in polymerisation reactions during application of photocuring light. Such reactive species may serve to initiate chain reactions which convert monomers into crosslinked macromolecules. By reacting with such radicals, oxygen may effectively limit or remove their contribution to the polymerisation process, thus reducing polymerisation efficiency.

As describe above, the susceptibility of a given ink to reduced polymerisation efficiency in the presence of oxygen, may be assessed by a number of means, including measurement of polymerisation rate or the time taken to reach full polymerisation (i.e. near 100% conversion of monomer to polymer) of a given monomer when exposed to photocuring light. The polymerisation depth of a given layer is directly proportional to the oxygen resistance and polymerisation rate, with extent of polymerisation measured by techniques known in the art, such as spectroscopy techniques including UV-Vis spectroscopy and Fourier-transform infrared (FTIR) spectroscopy. For some inks, oxygen inhibition will be sufficient to prevent full or 100% polymerisation, regardless of photocuring exposure time.

Increasing concentration of thiol components in a given photocurable ink may increase the polymerisation rate of the ink. The addition of thiol components may be particularly advantageous for spatially-controlled ink depositions, where increased surface area may result in increased oxygen inhibition of photopolymerisation. In this regard, increased thiol content may allow for improved resolution of a given photocured layer, as substantially all of the portion of a deposition exposed to a given pattern of photocuring light may be photopolymerised (i.e. the cured portion may better correspond to the pattern of photocuring light).

In some cases, thiol-acrylate-based photopolymerisation systems may be advantageous, as they can provide an adequate balance between oxygen resistance and ink shelf-life (i.e. stability). Persons of skill in the art will appreciate that in contrast some thiol-ene- and thiol-yne-based inks can exhibit relatively poorer shelf life, and that such inks should therefore be prepared shortly before use in printing applications. However, the oxygen resistance of acrylate-based systems and the shelf-life of thiol-ene- and thiol-yne-based systems can be improved by means of additives, such as additional free-radical scavengers, photoblockers, and photoinitators for example. Examples of some suitable additives are described in Charles E. Hoyle. An Overview of Oxygen Inhibition in Photocuring, RadTech e|5 2004 Technical Proceedings (Hoyle), the contents of which are incorporated by reference herein, in their entirety. As will be appreciated by those of skill in the art, photoinitators may be employed to modulate the photopolymerisation rate of the ink and the optimum wavelength of light for photopolymerisation. Free radical scavengers may be employed to improve the oxygen resistance of a given ink, while photoblockers may assist in modulating and improving z-direction resolution and/or imparting colour to the ink.

In some embodiments, the ink may comprise free-radical scavengers. Such free-radical scavengers may include tert-butylhydroquinone (TBHQ).

In some embodiments, the ink may comprise 0.1 to 10 parts w/w of TBHQ.

The amount of free-radical scavengers may be controlled in order to control the degree of photopolymerisation under given photocuring conditions. For example, the addition of free-radical scavengers may allow for a controlled increase in photopolymerisation rate (and therefore cured thickness depth) of a given ink deposition, for a given curing time.

For inks that are particularly susceptible to oxygen inhibition or atmospheric degradation, such as for acrylate-based photo-polymerisation systems or silanes, deposition may be carried out in a substantially inert atmosphere, such as under nitrogen for example. The substantially oxygen-free atmosphere can be obtained for example by purging the entire printing enclosure with inert gas, or by flowing the inert gas at the build layer i.e. the region where deposition and photopolymerisation of the ink is occurring. Non-thiol containing acrylate-based photo-polymerisation systems are known in the art (particularly for vat-based polymerisation processes) and may include urethane acrylate resins, such as urethane acrylate elastomers.

In some embodiments, the two or more photocurable inks may each comprise one or more organosilicon-based monomers.

In some embodiments, the one or more organosilicon-based monomers may be selected from the group consisting of functionalised polysiloxanes, polycarbosiloxanes, polysilsesquioxanes, polycarbosilanes, polysilylcarbodiimides, polysilsesquicarbodiimides, polysilazanes, polysilsesquiazanes, polyborosilanes, polyborosiloxanes and polyborosilazanes. Those of skill in the art will appreciate that a number of organosilicon monomer inks may be suitable, particularly where such inks exhibit acceptable oxygen resistance. As outlined above, oxygen resistance may be improved by a number of methods known in the art, such as the presence of thiol groups and/or provision of free-radical scavengers.

In some embodiments, one or more of the photocurable inks may comprise one or more additives selected from the group consisting of a free-radical scavenger, a photoblocker and a photoinitiator. In some embodiments, the photocurable inks may comprise one or more rheological modifiers. Such additives may be employed to increase or decrease the viscosity of the ink, in order to optimise deposition.

In some embodiments, the one or more of the photocurable inks may comprise particles. The particles may be dispersed or suspended in a photocurable carrier resin. The addition of particulate matter to inks or resins for printing may alter for example the rheological properties of the inks (e.g. the viscosity) and/or also impart particular mechanical and chemical properties to the final printed component. It may be desirable for example to add particulate matter to an ink, in order to increase the inks viscosity. This in turn may impart improved shape memory properties of the deposited ink (i.e. inks of increased viscosity are generally less prone to spreading on the work surface after deposition). In some embodiments, particles may be added, to increase the viscosity of an ink, to improve the mechanical strength of the printed component and/or to impart selective porosity or surface functionality.

In some embodiments, the porosity of the printed component may be modulated, by controlling the composition of one or more of the photocurable inks. For example, the composition of the first ink and the second ink may be selected such that a printed multi-material component exhibits a first porosity in portions of the part printed using the first ink, and a second porosity in portions of the part printed using the second ink. In this way, a consolidated 3D part can be fabricated having differing porosity in differing regions of the part. This may be advantageous in applications such as microneedle arrays for example, where controlling the porosity of the array can allow for highly controlled transdermal drug delivery.

Depending on the ink selected, the “as printed” object may display a degree of porosity. Alternatively, or additionally, the printed object may be subjected to a further processing step(s) in order to produce the desired porosity. For example, the printed part may be subjected to pyrolytic conditions to form a desired pore structure.

Thus, in some embodiments, the three-dimensional object is a precursor to a final part. In embodiments where the object is a precursor, it may be subjected to one or more further processing steps to provide the final part. For example, in some embodiments, one or more of the inks used may be a preceramic resin, such as a resin for forming a porous polymer-derived ceramic material. In some embodiments, by using the method disclosed herein the preceramic resin may be subjected to polymerising conditions to form a preceramic polymer or a polymerised green body. That is, in some embodiments, the three-dimensional object comprises preceramic polymer or polymerised green body. The preceramic polymer (or polymerised green body) may then be subjected to pyrolytic conditions. By subjecting the preceramic polymer (or polymerised green body) to pyrolytic conditions, a porous polymer-derived ceramic material may be formed. The final part, formed using the precursor three-dimensional object, may comprise porous polymer-derived ceramic material.

Depending upon the composition of the photocurable inks, the porous 3D part can be fabricated to contain micropores, mesopores and/or macropores (i.e. the part can be microporous, mesoporous and/or macroporous). The different size pores may also be formed in different quantities and in different distributions throughout the 3D object, depending upon the composition of the photocurable inks deposited, and the deposition and curing patterns employed for the first and second inks (i.e, where each of the first and second inks provide a differing pore size and/or distribution to their respective cured portions of the consolidated 3D object). This can result in printed objects formed with varying degrees and distributions of porosity. That is, by changing the relative amounts and/or components in the ink compositions, 3D objects can be fabricated with micropores, mesopores and/or macropores as desired, to achieve a target porosity (i.e. the porosity is “tunable”). In some embodiments, the formed porous 3D object may contain mesopores and one or both of micropores and macropores; i.e. the object may be mesoporous and one or both of microporous and macroporous. In this way, a printed object having a tailored, hierarchical porosity distribution may be fabricated.

Pores may be formed in the 3D object by the inclusion of porous ceramic particles in the photocurable ink. The particle size and type may be selected to control the pore size obtained in the printed object. For example, micropores may be introduced to the printed object by the use of microporous ceramic particles in the photocurable ink. Similarly, micropores and/or mesopores may be introduced by the use of mesoporous ceramic particles (micropores may also be formed from mesoporous ceramic particles, by pore shrinkage during pyrolysis—for example, mesopores of diameter 2-3 nm may become micropores of diameter 1-2 nm during pyrolysis). This may allow objects printed according to the method disclosed herein to find utility in new applications requiring specific pore size or porosity. The use of particles in the inks can also provide mechanical strength to a printed component and/or contribute to the appearance of the object e.g. by imparting colour.

Suitable particles may be porous ceramic particles selected from the group comprising SiO₂, Si₃N₄, SiC, SiCN, SiCO, SiCNO, SiBCN, SiBCO, SiAlCN, and SiAlCO particles. In some embodiments, the particles may be silica (SiO₂) particles. The porous ceramic particles may be of any size fit for purpose. For example, particle sizes of up to 1 mm may be suitable, depending upon the orifice size of the ink deposition arrangement employed. In some embodiments, the ceramic particles may be microparticles. By “microparticles” as defined herein are a plurality of particles having a particle size falling between 1 μm and 1 mm. In some embodiments, the microparticles may have a size falling between 1 μm and 500 μm, between 1 μm and 200 μm, between 1 μm and 100 μm, or between 1 μm and 50 μm. In some embodiments, the particles may be nanoparticles (i.e. having a particle size below 1 μm). In some embodiments, the nanoparticles may have a size below 500 nm, below 200 nm or below 100 nm.

It is common for particulate materials to be supplied with a specified particle size range which usually reflects that at least a majority portion of those particles have a size within that range. This may be described as a particle size distribution. The particles may be predominantly within that particle size range (e.g. >95% or >99% for example). In some embodiments, at least 90%, 95%, 98%, 99%, 99.5% and even 99.9% of the ceramic particles included in the ink have a size of between about 1 nm and 1 mm, between about 1 nm and 500 μm, between about 1 nm and 200 μm, between about 1 nm and 100 μm, or between about 1 nm and 50 μm.

When porous particles are present in the photocurable ink, they may be present in an amount of at least about 0.5%, 1%, 2%, 5%, 8%, 10% or at least about 15% by weight of the ink. In some embodiments, the amount of the porous particles may be less than about 95%, 90%, 70%, 50%, 30%, or about 25%, by weight of the ink. The amount of the porous ceramic particles by weight of the ink may be influenced by the size and density of the particles and as such can be included in the ink on a volume basis, in which case the porous ceramic particles may be present in the ink in an amount of at least about 0.1%, 0.5%, 1%, 2%, 5%, 8% or at least about 10% by volume of the ink. The amount of the porous ceramic particles may be not more than about 98%, 95%, 90%, 80% or not more than about 70% by volume of the ink. Any minimum and maximum can be combined without restriction. For example, the amount may be between 0.5% and 95% by weight of the ink, between 0.5% and 25% by weight of the ink, between about 0.1% and 98% by volume of the ink or between 0.1% and 70% by volume of the ink, etc. In the case of micro- and mesoporous nanoparticles for example, an amount of between about 1 wt % to about 30 wt %, preferably between about 2 wt % to about 25 wt %, more preferably between about 2 wt % to about 20 wt %, of the ink, has been found to provide materials containing micropores which contribute to a porosity which is useful in the applications described above.

Manufacturing of porous components may require either the use of porous particles or inks comprising polymer-derived ceramic (PDC) material monomers with different ceramics yields. The use of porous particles can provide micro (<2 nm) and meso (2-50 nm) porosity, while the use of PDCs with different ceramic yields can provide meso (2-50 nm) and macro (>50 nm) porosity. Depending upon the intended application, either or both approaches may be employed. Nanoparticles in particular may allow a high loading percentage to be achieved and provide more uniform resin systems, with lower viscosities, compared to the use of micro particles.

One or more inks selected for use in the method disclosed herein may be a photocurable ink as described in International Patent Application Nos. PCT/AU2023/050159 and PCT/AU2023/050161, the contents of each of which are herein incorporated by reference in their entirety.

The inks may be prepared by thorough mixing of the required components, for example using vortex mixers, sonicator or ultrasonic baths, etc. Prepared inks may be purged with an inert gas (e.g. nitrogen), for example to limit reaction of the inks with oxygen. In this regard, the prepared inks may be exposed to a vacuum, prior to loading of the prepared inks into the ink deposition arrangement.

In some embodiments, the one or more inks may have a viscosity in the range of about 0.1 Pa·s to 1000 Pa·s, which may be determined by means of a viscometer, as known in the art (for example the DV2T Viscometer as supplied by Brookfield or via Ostwald viscometry). Those of skill in the art will readily appreciate that the suitable viscosity range will vary depending upon the particular ink deposition arrangement employed.

In some embodiments, selectively exposing said deposited ink to said light source may comprise generating a pattern of photocuring light, and projecting said pattern upon at least a portion of said deposited inks. In this regard, the generated pattern may approximate the required geometry of a layer of the part to be printed. That is, “generated pattern” can refer to any type of pattern generated in accordance with a design that is determined prior to the initiation of the light exposure.

In some embodiments, the projected pattern of light or image may be generated by a combination of pixels having differing wavelengths and/or intensity. In such embodiments, the application of a curing pattern of light comprising regions of differing light properties can result in controlled curing of selected portions of the deposited ink/s.

The light source can be positioned adjacent to the ink deposition arrangement, which can minimise the amount of relative movement of the work surface required between deposition and photocuring processes (i.e. after a deposition process, the work surface may be repositioned relative to the light source, in order to selectively cure a portion of the deposited material). By positioning the light source adjacent to the deposition arrangement (e.g. adjacent to one or more deposition nozzles), the amount of relative movement of the work platform in the x-y plane can be minimised, to thereby reduce the time between ink deposition and curing. This can limit the amount of spreading of deposited ink (i.e. after deposition but before curing), particularly for less viscous inks, and result in retaining an improved initial deposited geometry, prior to curing into a consolidated geometry of the 3D part.

The light source may take the form of a projector. That is, in some embodiments, the light source is configured for direct light projection photo-curing of the inks. Direct light projection (DLP) photo-curing can differ from other modes of photo-curing in that, rather than a light source (e.g. a laser) tracing the region to be cured, in DLP photo-curing patterned light reflecting the cross-section to be cured is projected onto the surface of the deposited ink(s). By using projection optics, DLP can employ a digital mask to provide light in the desired pattern for the curing process. In some embodiments, the pattern may be configured to cure only one of the inks or to cure both inks simultaneously.

In some embodiments, the high resolution of DLP-based printers (e.g. <10 μm pixel size) may be attributed to their use of digital micromirror device (DMD)-based projectors, to cast a geometric image approximating each layer onto the deposited ink. The regions of the ink layer exposed to light pixels may be polymerised to form the solid regions of each layer of the 3D part, whereas the regions exposed to dark pixels (i.e. an absence of polymerising light) remain unpolymerised (i.e. uncured). Hence, the x- and y-resolution within a given printed layer using DLP photo-curing may be governed, at least in part, by the pixel size of the projector.

Prior art DLP-based printers typically rely on vat photo-polymerisation, where liquid resin is stored in a vat, and the material for printing each layer is dispensed by creating a thin space between the top-mounted build stage and the vat floor. This method of resin dispensing results in many of the limitations observed with current DLP printers. The thin space created between the vat floor and the build stage may not be suitable for the uniform flow of viscous resins for example. Further, the top-mounted build stage of such vat systems may fail to provide the support required to hold heavy objects, resulting in the failure of the entire print cycle. More importantly, multi-material printing in this configuration requires interchanging multiple vats filled with individual resins, with extensive washing steps required between each step. This is a cumbersome and often manual process, and it results in extended print times for completion of components. The inability to use more than one material with DLP printers not only limits their use for printing multi-material objects, however, it also limits their use for printing complex structures, because complex structures often require an additional support material to prevent their collapse. Hence, a new working principle and configuration is disclosed herein, where, in some embodiments, the light source comprises a DLP-based arrangement. Such arrangements may aid in multi-material 3D printing, while retaining high print resolution and speed.

The traditional vat-based material dispensing unit of DLP printers is substituted with a direct-ink writing (DIW) arrangement, where, in some embodiments, syringes may be used to provide spatially controlled resin dispensing. In some embodiments, syringe-based material dispensing may allow easy integration of multiple syringes for multi-material printing. Moreover, syringe extrusion may be used to dispense even viscous inks, such as nano-composites, as often used for ceramic 3D printing. Viscous inks may allow better shape retention of the deposited layer of ink; hence they may be preferred for DIW processes. Inks having low oxygen resistance may be unsuitable for DIW, as the relatively large exposed-surface area of the deposited ink may limit the ability of the deposited ink to be cured e.g. to be fully cured through the thickness of the deposited ink. The inks may be dispensed for each layer, according to the desired geometry of the layer, marking the solid components of the layer with the build materials and in some cases the hollow components of the layer with support material or the absence of any material. Similar to the PolyJet printers, the use of additional support materials in these printers can assist in the printing of complex structures.

Syringe extrusion alone may however provide a lower than desired resolution, because the extrusion nozzles may be limited to large diameters (e.g. >300 μm for viscous inks), and the dispensed ink may further spread on the work surface after deposition. In the present disclosure, the dispensed layers may be used to only roughly mark the desired layer geometry with relatively thick strokes of ink, while the final print resolution in the x- and y-directions may be obtained by selectively curing the dispensed layers, such as with, in some embodiments, high-resolution DLP. As soon as the layers are dispensed, they may be transferred to the curing area in some embodiments by moving the work surface (build) stage. In other embodiments, the light source may be moved instead of the work surface. The use of a build/ground stage may also minimise mechanical stress on the printed parts, allowing the successful printing of even heavy objects. In some embodiments, the hybridisation of the DIW/DLP printing processes may be assisted by using oxygen-resistant photocurable systems. In some embodiments, the photocurable systems may comprise thiol-acrylate or thiol-ene-based inks, since they may allow faster and higher resolution spatially controlled photo-polymerisation. In particular, thiol-acrylate or thiol-ene-based inks, may exhibit relatively high oxygen resistance, as described above.

The distance of the light source from the work surface (i.e. in the z-direction) may be adjusted to modulate the exposure of the deposited ink/s to the photocuring light. The z-distance can affect, for example the area of light exposure, effective pixel size, light intensity, and focus of the projected light. Light source properties may also be modulated by adjusting the projector, for example by adjusting the light intensity and/or focus for a given relative position between the light source and work surface.

Exposure of the deposited ink to the photocuring light will typically cause a central or lower-most portion of the exposed ink, relative to the light source, to begin curing first, because that portion of ink experiences the least exposure to oxygen. In this way, curing of portions of ink exposed to the photocuring light will proceed along the z-direction, starting at the level nearest the work surface and proceeding upwardly through the deposited ink, in a direction toward the light source (i.e. in a ‘bottom-up’ fashion). In some embodiments, the entire thickness of the deposited ink may be cured (i.e. a ‘full cure’ in the z-direction), though other portions of the ink may optionally remain uncured (i.e. portions of ink in the x-y direction of the deposition). In this regard, the light source can also be moved relative to the work surface in the z-direction during the curing operation, in order to progressively cure the deposited ink in a through-thickness (z) direction of the component. In this way, deposited ink may be cured in a stepwise fashion, thereby ultimately forming one or more consolidated layers of the 3D component.

In some embodiments, exposure to said light source may be carried out for an exposure time of between about 1 millisecond to 1 hour. In some embodiments, exposure to said light source may be carried out for an exposure time of between about 100 milliseconds to 500 seconds. In some embodiments, exposure may be carried out for between about 60 seconds to 200 seconds. One of skill in the art will appreciate that optimal exposure time will depend upon a range of factors, including ink composition, viscosity, curing conditions, etc., though it may be advantageous in some embodiments to minimise curing time, which may result in reduced fabrication time for the final printed component.

In some embodiments, the light source may produce a photocuring light having a wavelength within the UV or visible spectrum. The wavelength may be in the range of about 360 nm to about 420 nm. For example, a wavelength of approximately 405 nm may be suitable for particular inks and required curing times. For other ink systems and printing conditions, a wavelength of about 365 nm, 385 nm, or 405 nm may be preferred. A person of skill will appreciate that the photocuring wavelength can be selected depending upon the material to be cured for example.

The photocuring light source may be as otherwise described in International Patent Application Nos. PCT/AU2023/050159 and PCT/AU2023/050161. As noted above, the contents of each of which are herein incorporated by reference in their entirety.

As explained above, photo-curing of the ink proceeds in the z-direction direction, often commencing at the level nearest the work surface and proceeding upwardly in a direction toward the light source. In some embodiments, the curing may be performed so that the complete z-direction thickness of the deposited layer is cured (i.e. 100% polymerisation in the z-direction). Alternatively, in some embodiments, only part of the z-direction thickness is cured. That is, in some embodiments, the photocuring conditions may be selected so as to control z-direction resolution of the cured portion.

The present invention embraces a method for fabricating a three-dimensional object layer-by-layer upon a work surface using one or more photocurable inks, the work surface configured to be moveable relative to an ink deposition arrangement and a light source, the method comprising forming a layer of the three-dimensional object. Forming a layer of the three-dimensional object comprises: depositing photocurable ink; and selectively exposing the deposited ink to the light source, to thereby cure at least a portion of the deposited ink; the cured portion forming at least part of a layer of the three-dimensional object.

It will be appreciated that in embodiments where one ink is employed, the ink may be of any type and/or composition and include one or more additives, as described above.

It will also be appreciated that in embodiments where one ink is employed, the composition of the ink may be controlled so as to modulate the porosity of the three-dimensional object, as described above. In some of these embodiments, the “as printed” object may be subjected to a further processing step(s) in order to produce the desired porosity, as described above.

In some of these embodiments, the z-aspect is controlled by the photocuring, in addition to the initial ink deposition parameters. In particular, in a second aspect there is disclosed a method for fabricating a three-dimensional object layer-by-layer upon a work surface using one or more photocurable inks, the work surface configured to be moveable relative to an ink deposition arrangement and a light source, the method comprising, for one or more layers of the three-dimensional object, forming said layer of the three-dimensional object, said forming of said layer comprising:
depositing a photocurable ink to a first thickness, determined in a direction normal to a plane of the work surface; and
selectively exposing the deposited ink to the light source, to thereby cure at least a portion of the deposited first ink;
wherein the selective exposure of the deposited ink to the light source is configured such that said cured portion extends to a cured thickness, determined in a direction normal to a plane of the work surface, the cured thickness being less than or substantially equal to the deposited thickness.

In some embodiments, the x-, y- and z-direction resolution of the cured part may each be controlled by the photo-curing conditions.

In some embodiments, it may be advantageous to fully cure the entire thickness of the deposition (e.g. 90% polymerisation or more, such as substantially 100% polymerisation), for each layer. In some embodiments, for a least one layer, it may be advantageous for the cured thickness to be less than the deposited thickness.

In some embodiments, the remaining uncured portion of the deposited ink may be substantially removed, to thereby expose a surface of the cured portion. Excess uncured ink that overlies a cured portion of the 3D component can be removed (e.g. by mechanical, chemical or by evaporative cleaning), prior to deposition of fresh, uncured ink, followed by a further curing operation. Such cleaning may include spraying or immersion in a suitable solvent, followed by air drying, prior to subsequent deposition of additional ink layers.

In some embodiments, a subsequent layer of the three-dimensional object may be formed, so as to overlay at least a portion of said exposed surface.

In some embodiments of the second aspect, the inks selected may be a photocurable ink as described above for the first and second inks.

In some embodiments, the forming of a layer of the three-dimensional object may further comprise:
depositing a second photocurable ink to a second thickness, determined in a direction normal to a plane of the work surface; and
selectively exposing the deposited second ink to the light source, to thereby cure at least a portion of the deposited second ink;
   wherein the cured portions of the first ink and the second ink form at least part of a layer of the three-dimensional object and wherein the selective exposure of the deposited second ink to the light source is configured such that said cured portion of the second ink extends to a cured thickness, determined in a direction normal to a plane of the work surface, the cured thickness of the second ink being less than or substantially equal to the deposited thickness of the second ink.

Additional embodiments of the second aspect may otherwise be as described for the first aspect.

Also disclosed is a system for fabricating a three-dimensional object layer-by-layer using one or more photocurable inks, said system comprising:
a work surface upon which the three-dimensional object is fabricated;
an ink deposition arrangement configured for spatially controlled depositing of layers comprising one or more photocurable inks, each layer being in an initial ink deposition; and
a light source configured for selectively exposing each initial ink deposition to light so that at least part of said initial ink deposition is photocured to provide a consolidated layer of the three-dimensional object;
   wherein the relative positioning of the work surface to the ink deposition arrangement and the light source is variable.

The system is suitable for use in performing the method disclosed herein.

In some embodiments, the system may comprise an ink removal arrangement configured for removing at least a portion of an uncured part of said initial ink deposition. In such embodiments, the system may be configured for performing the method according to the second aspect.

In some embodiments, the system may be configured for fabricating the three-dimensional object using two or more photocurable inks, the cured portions of the two or more inks forming at least part of a layer of the three-dimensional object. In such embodiments, the system may be configured for performing the method according to the first aspect.

### BRIEF DESCRIPTION OF THE DRAWINGS

Embodiments will now be described by way of example only, with reference to the accompanying drawings in which:

FIGS. 1A and B are perspective schematic views of a 3D printer according to a first embodiment of the invention, the 3D printer having a single ink dispenser;

FIGS. 2A, B and C are, respectively, front side and back schematic views of the 3D printer of FIG. 1;

FIGS. 3A to E illustrate a second embodiment of a 3D printer according to the present invention. FIGS. 3A, B and C illustrate, respectively, back, side and front plan views.

FIGS. 3D and E illustrate, respectively, front and back perspective views;

FIGS. 4A to E illustrate a third embodiment of a 3D printer according to the present invention. FIGS. 4A, B and C illustrate, respectively, back, side and front plan views.

FIGS. 4D and E illustrate, respectively, front and back perspective views;

FIGS. 5A to E illustrate a fourth embodiment of a 3D printer according to the present invention. FIGS. 5A, B and C illustrate, respectively, back, side and front plan views.

FIGS. 5D and E illustrate, respectively, front and back perspective views;

FIGS. 6A to E illustrate a fifth embodiment of a 3D printer according to the present invention. FIGS. 6A, B and C illustrate, respectively, back, side and front plan views.

FIGS. 6D and E illustrate, respectively, front and back perspective views;

FIGS. 7A to E illustrate a sixth embodiment of a 3D printer according to the present invention. FIGS. 7A, B and C illustrate, respectively, back, side and front plan views.

FIGS. 7D and E illustrate, respectively, front and back perspective views;

FIGS. 8A to E illustrate a seventh embodiment of a 3D printer according to the present invention. FIGS. 8A, B and C illustrate, respectively, back, side and front plan views. FIGS. 8D and E illustrate, respectively, front and back perspective views;

FIGS. 9 (a) and (b) illustrate, respectively, front and side views of a portion of the 3D printer of the third embodiment, according to the present invention;

FIG. 9 (c) illustrates schematically the projection of photopolymerising light onto a multi-material layer, according to the present invention;

FIG. 9 (d) illustrates the effects of free radical scavenger (TBHQ) addition and varied light exposure time to the degree of curing completion achieved for various resin (ink) systems;

FIGS. 10 (a) and (b) illustrate, respectively, the curing depth and degree of curing completion achieved for various resins systems, as a function of light exposure time;

FIGS. 10 (c)-(e) illustrate schematic flow diagrams of printing methods, according to embodiments of the present invention;

FIGS. 11A (a)-(c) illustrate, respectively, a CAD render of a model to be printed, a photograph of a printed object obtained from traditional DIW-based 3D printing, and a photograph of a printed object obtained from a hybridised DIW and DLP-based 3D printing, in accordance with the present disclosure, with FIGS. 11 (a), (b) and (c) being drawings reflecting FIGS. 11A (a), (b) and (c), respectively;

FIGS. 12A (a), (b), (c) and (d) illustrate, respectively, a CAD render of a model to be printed, a photograph of a printed object obtained by deposition of a single resin, a photograph of a printed object obtained by deposition of two adjacent resins, and an image of a photocuring light pattern, in accordance with the present disclosure, with FIGS. 12 (a), (b) and (c) being drawings reflecting FIGS. 12A (a), (b) and (c), respectively and FIG. 12 (d) being a halftone render reflecting FIG. 12A (d);

FIGS. 13A (a) and (b) illustrate, respectively, a CAD render of a model to be printed and a photograph of a printed multi-material component, in accordance with the present disclosure, with FIGS. 13 (a) and (b) being drawings reflecting FIGS. 13A (a) and (b), respectively;

FIGS. 14A (a) and (b) illustrate SEM images of a microneedle array, printed in accordance with the present disclosure, with FIGS. 14 (a) and (b) being halftone renders reflecting FIGS. 14A (a) and (b), respectively;

FIG. 15A illustrates a further microneedle array, printed in accordance with the present disclosure, with FIG. 15 being a halftone render reflecting FIG. 15A;

FIGS. 16A (a), (b) and (c) illustrate, respectively, a CAD render of a model to be printed, a photograph of a printed object obtained by deposition of two adjacent resins, and an SEM image of the printed object, in accordance with the present disclosure, with FIGS. 16 (a) and (b) being drawings reflecting FIGS. 16A (a) and (b), respectively and FIG. 16 (c) being a halftone render reflecting FIG. 16A (c);

FIG. 17A illustrates a photograph of a printed object in the form of an electro-osmotic pump printed in accordance with the present disclosure, with FIG. 17 being a halftone render reflecting FIG. 17A;

FIG. 18A illustrates a photograph of a further microneedle array, printed in accordance with the present disclosure, with FIG. 18 being a halftone render reflecting FIG. 18A;

FIG. 19A illustrates a photograph of a further microneedle array, printed in accordance with the present disclosure, with FIG. 19 being a halftone render reflecting FIG. 19A; and

FIG. 20A illustrates a photograph of a section through an object, printed in accordance with the present disclosure, with FIG. 20 being a halftone render reflecting FIG. 20A.

### DESCRIPTION OF ILLUSTRATED EMBODIMENTS

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

In reference to the figures, like reference numerals have been used to denote like parts.

As used herein, the terms ink, resin, deposition materials, etc. are used interchangeably, to refer to materials deposited during 3D printing.

Also disclosed herein is a system for fabricating a three-dimensional object layer-by-layer using one or more photocurable inks, said system comprising: a work surface upon which the three-dimensional object is fabricated; an ink deposition arrangement configured for spatially controlled depositing of layers comprising one or more photocurable inks, each layer being in an initial ink deposition; and a light source configured for selectively exposing each initial ink deposition to light so that at least part of said initial ink deposition is photocured to provide a consolidated layer of the three-dimensional object; wherein the relative positioning of the work surface to the ink deposition arrangement and the light source is variable. Such a system may be a printer. Alternatively, such a system may comprise a printer together with other suitably disposed and configured device(s) so as to provide the system.

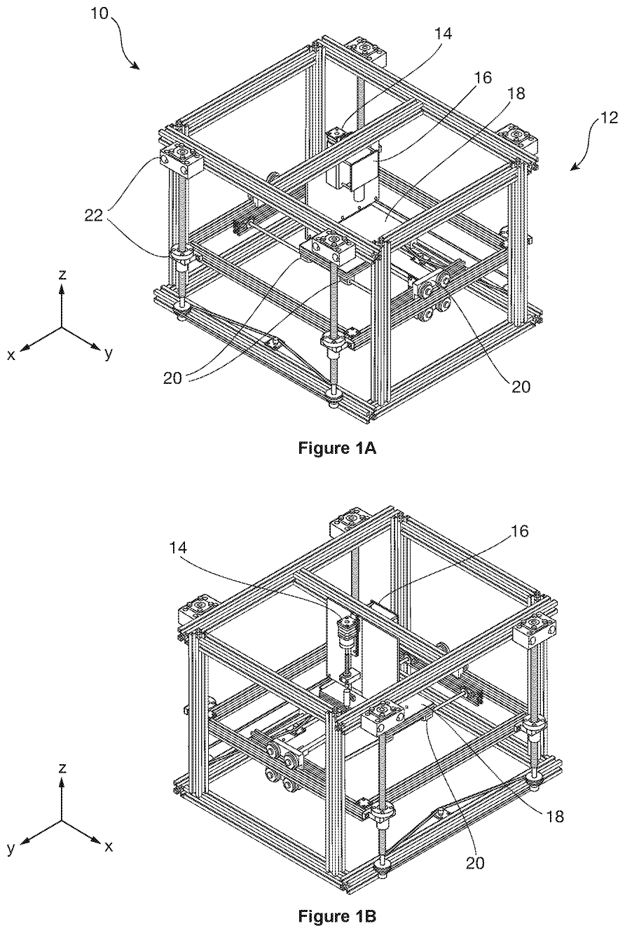

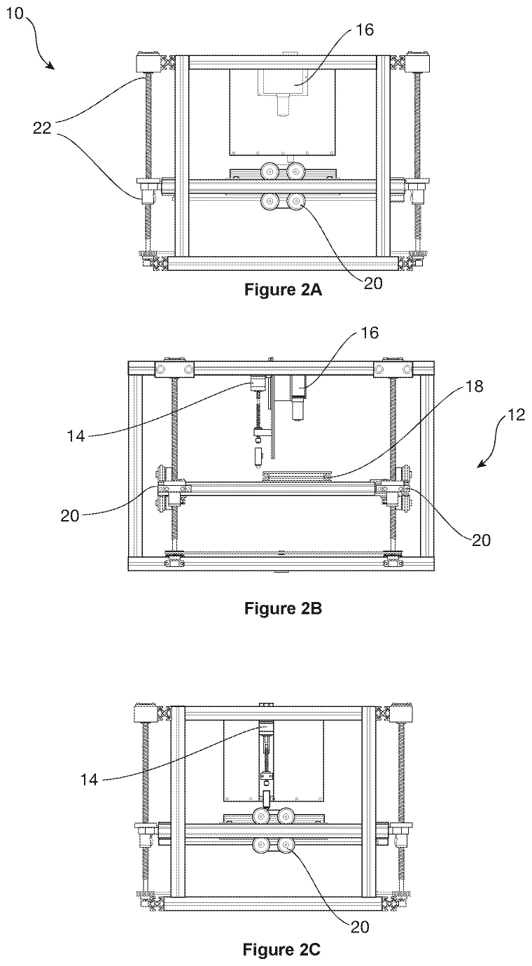

A first form of a printer for use according to the invention is described by reference to FIGS. 1A-2C. The printer 10 may form part of a system for fabricating a three-dimensional object layer-by-layer using one or more photocurable inks. In some embodiments, such a printer may be included in a system suitable for performing methods in accordance with at least the second aspect disclosed herein.

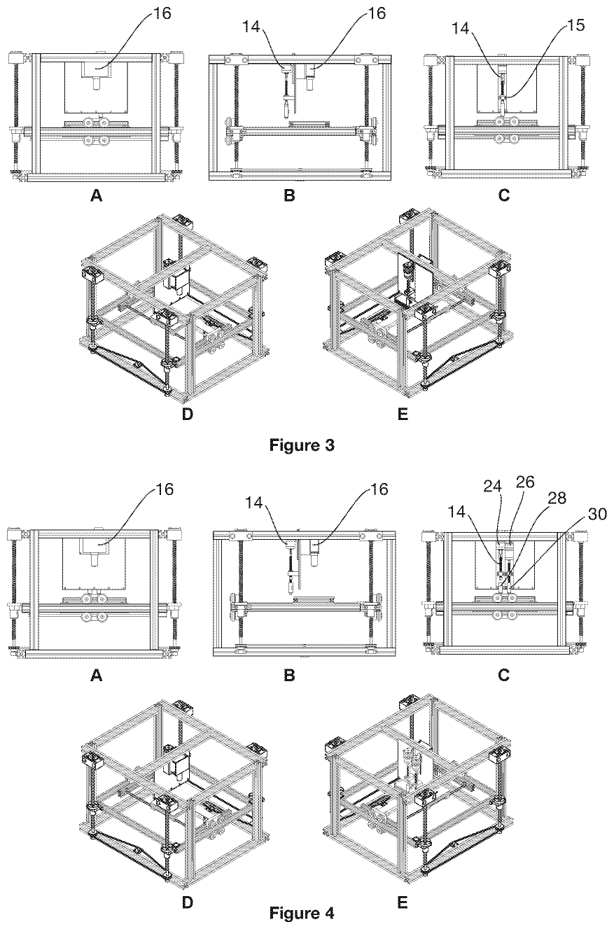

The three-dimensional (3D) printer 10 typically includes a frame unit 12 or enclosure, for supporting components of the printer. The printer comprises an ink deposition arrangement 14, a light source 16 and a work surface 18. In this illustrated embodiment, the ink deposition arrangement 14 of the printer 10 has a single ink dispenser and, as such, is suitable for performing methods in accordance with at least the second aspect disclosed herein. It will be appreciated that such a printer can be configured with plural ink dispensers (see e.g. FIG. 4).

The work surface 18 or build platform is moveable relative to the ink deposition arrangement 14 and light source 16, in x, y and z directions (i.e. in three orthogonal axes), defining a three-dimensional, orthogonal coordinate system. For fabrication of the three-dimensional object, the work surface 18 is moved relative to the ink deposition arrangement 14 and light source 16, in order to form each layer of the object. During ink deposition for a given layer, the ink deposition arrangement 14 is moved relative to the work surface 18 to deposit photocurable ink in a spatially controlled manner, providing an initial or “gross” ink deposition upon the work surface 18. The deposited ink is then selectively photocured by means of the light source 16, to cure at least a portion of the deposited ink and form at least part of a layer of the three-dimensional object.

During ink deposition for a given layer of the object, or after a photocuring process to consolidate or cure a part of the deposited layer, the ink deposition arrangement may be provided with an ink of a different composition, in order to deposit more than one ink type within a given layer of the object. Subsequent photocuring by the light source 16 can then produce a consolidated layer of the component, containing more than one material type. The type or composition of inks loaded into the ink deposition arrangement 14 can also be changed between deposition and curing steps for a given layer of the object, in order to for example, fabricate an object having consolidated layers of alternating material types.

The work surface 16 can be moved relative to the deposition arrangement 14 and light source 16 by means of actuators 20, 22, which can control relative displacement of the work surface 16 in the x-y and z planes, respectively. The actuators 20, 22 illustrated in FIGS. 1A-2C can comprise electric stepper motors, timing belts and lead screws, though it should be appreciated that the actuators can be of any suitable type known in the art (e.g. electric, pneumatic, etc).

FIG. 4 illustrates an embodiment of the printer according to the present invention. In this illustrated embodiment, the printer is suitable for fabricating a three-dimensional object layer-by-layer using two or more photocurable inks. The ink deposition arrangement 14 comprises a first 24 and a second 26 ink dispenser and, as such, is suitable for performing methods in accordance with at least the first aspect of the disclosure. The ink dispensers 24, 26 in the embodiment of FIG. 4 comprise screw-driven pistons for actuating syringes 28, 30 in order to deposit ink onto the work surface 16. The first 24 and second 26 syringes can contain different inks (e.g. photopolymerisable monomers), and can be actuated separately or simultaneously, in order to deposit one or both of the contained inks at a given position relative to the work surface 16. Typically, the work surface 16 is provided with a removeable upper surface onto which the ink/s are deposited and the resulting 3D article is fabricated. Such surfaces include glass or metal slides for example.

FIGS. 3 and 5-8 illustrate various additional embodiments of the 3D printer according to the present invention.

FIG. 3 illustrates an embodiment of the printer, where the ink deposition arrangement 14 comprises an inline mixer 15, to allow online mixing of different resin components, immediately prior to extrusion of the mixed resins onto the work surface. Online mixing can be used for example to improve the shelf-life of unstable resin compositions (i.e. by delaying to formulation of such unstable compositions until immediately before extrusion onto the work surface), such as thiol-ene or thiol-acrylate-based resins, or to minimise the sedimentation of dispersed phases within the mixed resins, such as nano-composites. The dispersibility and resin shelf-life can be further improved by incorporating a sonic probe and temperature control units around the syringes, respectively.

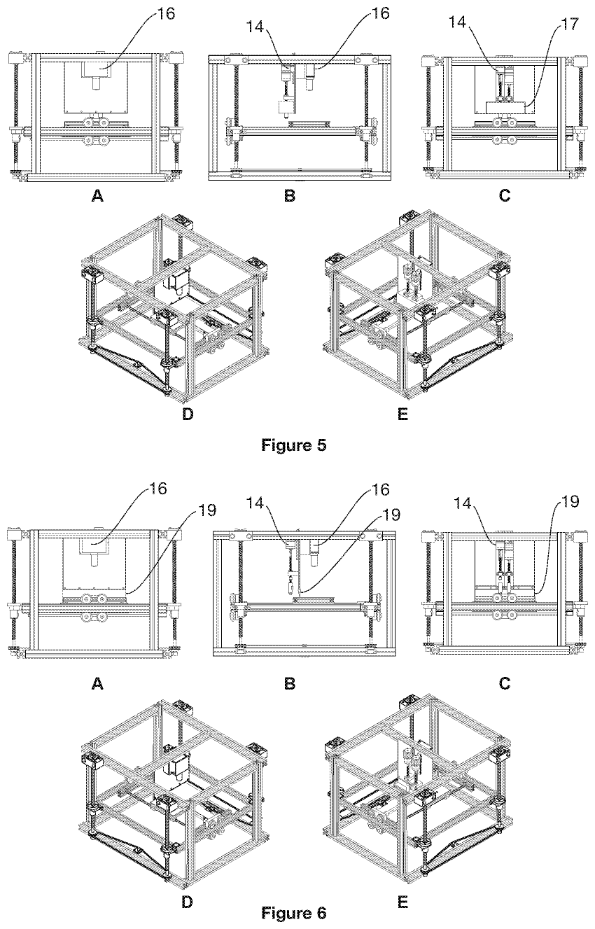

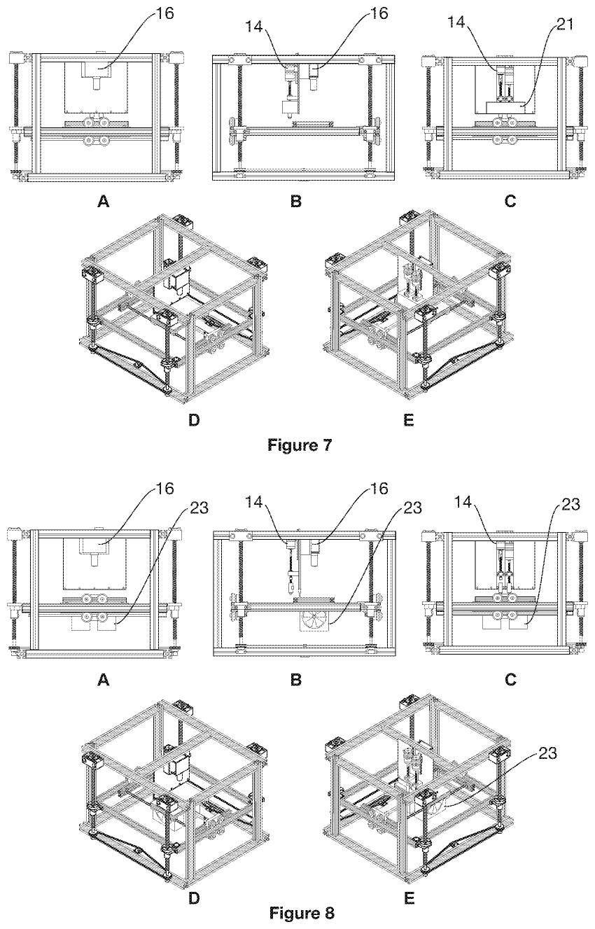

FIG. 5 illustrates an embodiment of the printer, where the ink deposition arrangement 14 comprises a sonic probe 17. The sonic probe 17 can be employed to help maintain particles or other components of a composite ink well-dispersed (e.g. to maintain a well-dispersed suspension).

The system for fabricating the three-dimensional object may comprise an ink removal arrangement configured for removing at least a portion of an uncured part of an ink deposition. FIG. 6 illustrates an embodiment of the printer comprising an ink removal arrangement in the form of a wiper blade arrangement 19. In some other embodiments, there is provided a system in which the ink removal arrangement is for cleaning surplus (uncured) ink. Such cleaning may include spraying or immersion in a suitable solvent, followed by air drying, prior to subsequent deposition of additional ink layers. Accordingly, the ink removal arrangement may comprise a solvent spraying mechanism and, optionally, a dryer (e.g. a fan or other dryer for providing a drying gas flow, such as air or nitrogen).

The wiper blade arrangement 19 is positioned between the ink deposition arrangement 14 and the light source 16 (as shown in FIG. 6B) and can be employed to remove part or substantially all of the uncured resin layer that may remain atop a cured surface after the photocuring step. For example, an embodiment of the printer such as that illustrated in FIG. 6 may be employed to perform a method in accordance with the second aspect. The printer may be used to control z-direction resolution of the cured portion, with the wiper removing part or all of the uncured portion, to further enhance the z resolution of the component.

FIG. 7 illustrates an embodiment of the printer comprising a heating and/or cooling unit 21, mounted adjacent the ink deposition arrangement 14. The heating and/or cooling unit 21 can be employed to modulate ink viscosity, for example while the ink is stored in the syringe or as it is extruded. In some embodiments, heating and/or cooling may be employed as the ink is extruded to control curing rates.

FIG. 8 illustrates an embodiment of the printer, comprising a heating and/or cooling unit 23, mounted adjacent the work surface 16, for controlling the temperature of the work surface 16. The heating and/or cooling unit 23 can be employed to either increase the viscosity and shape retention of the deposited ink (by cooling), initiate polymerisation (by heating), or shrink the layer height (in the z-direction) and thickness (in the x-y direction) through controlled evaporation of uncured ink (by heating). In some embodiments, heating and/or cooling may be employed to ink control curing rates.

During ink deposition and curing processes, the relative positions of the ink deposition arrangement 14, light source 16 and work surface 18 may be configured and controlled via a computer system having a navigation module or via manual user control. Where a computer system is employed for controlling the relative positioning and the actuation of the ink deposition arrangement to deposit one or more inks, software can be employed to control the printer based upon computer-aided design (CAD) model files of the 3D part (or layers thereof) to be fabricated. Such software can employ G-code (RS-274) for example, as a programming language for control of the printer.

The printer can, in some forms, include two controller units which can communicate with the navigation unit. One controller unit can control movement of the work surface 18 and/or movement and actuation of the deposition arrangement 14 (through the control of stepper motors for example), while a second controller unit can control the light source 16.

A temperature control unit for each of the build platform and the dispensing unit may also be employed. Temperature control may be used to modulate the rheology and curing/polymerisation rate of the dispensed ink. Thus, temperature control may improve the inks shape retention and extrusion properties, and the resolution of the final component. A micro-extruder for online mixing of different resin components may also be employed. The printer may also be equipped with a sonicator mixing unit for the ink deposition arrangement. This may be particularly advantageous for forms of the printer employing online mixing of inks and ink components, in order to improve the dispersion and stability of the ink formulations.

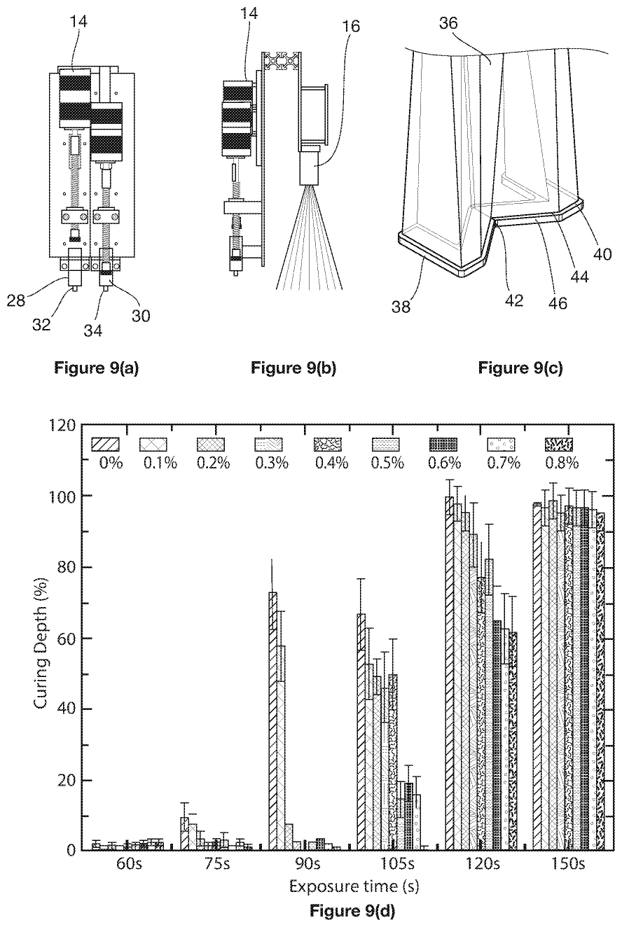

Turning to FIG. 9 (a), the ink deposition arrangement is illustrated with a syringe 30 in an actuated configuration (i.e. with its respective piston driven to expel ink from the syringe 30), in order to deposit a portion of the contents of syringe 30. In contrast, syringe 28 is unactuated in this position, thus only a portion of the contents of syringe 30 is deposited in this instance. FIG. 9 (a) also illustrates extrusion nozzles 32 and 34, through which respective inks are deposited. The extrusion nozzles may be integrated with their respective syringe, for fluid communication of ink held in the syringe, through the nozzle and onto the underlying workpiece (not shown in FIG. 9 (a), or (b)). FIG. 9 (b) illustrates the adjacent position of the ink deposition arrangement 14 and light source 16. Such adjacent positioning can limit the amount of relative movement required of the work surface in the x-y direction, for positioning the work surface relative to the ink deposition arrangement 14 and light source 16, during respective deposition and curing operations for a given layer of the 3D part being fabricated.

FIG. 9 (c) illustrates a pattern of photocuring light 36, projected upon a layer of deposited ink to be cured. The layer of deposited ink comprises a first ink 38 and a second ink 40, forming a deposition layer of the 3D object.

The pattern of photocuring light 36 may broadly correspond to the geometry of the deposited inks (i.e. the geometry as produced during deposition of the inks), though it can be seen that the pattern of photocuring light 36 is projected upon only a portion of the deposited inks (i.e. an outer boundary portion of the deposited inks is not exposed to the photocuring light). By selectively exposing the deposited inks to this pattern of photocuring light to form a consolidated layer of the 3D part, a cured portion 44 (parts of the ink exposed to the photocuring light) and an uncured portion 46 (parts of the ink not exposed to the photocuring light) are ultimately produced. In this way the cured portion 44 can define a subset of the deposited ink, or a refined geometry of the deposited ink. The refined geometry defines the geometry of a cured layer of the 3D part.

FIG. 9 (c) also illustrates an interface 42, where the first 38 ink and a second 40 ink depositions meet in forming an ink deposition layer. In cases where each of the first and second inks are deposited in such an adjacent relationship, prior to curing of either ink (i.e. the inks contact one another while in their uncured states), the first and second inks may be selected to limit any undesirable interfacial reactions with one another. Adjacent inks may also be selected so as to minimise any delamination during or after printing, especially when the printed parts are subjected to extensive post-treatment procedures, such as pyrolysis. Minimisation of such physical and or chemical differences between adjacent inks can reduce the likelihood of failure of the 3D part e.g. due to delamination for example.

In some cases, the interface 42 where the first 38 ink and a second 40 ink depositions meet, may become a diffuse interface i.e. the first and second deposited inks may mix or intermingle across a region adjacent the deposited interface, forming a concentration gradient. Such interactions may be preferred in some cases (i.e. to produce a strong consolidated layer after photocuring). For example, the approach of mixing two inks at the interface may be beneficial for dissimilar inks, such as inks with hydrophilic and hydrophobic properties that might otherwise separate out from each other.

In other cases, a distinct, sharp interface 42 between dissimilar inks can be obtained, for example by curing one ink before depositing the second, adjacent ink. This can be useful for inks with low viscosity and high surface energy, helping the inks to bond with each other.

The interface 42 can also be further controlled by the selective photocuring of the deposited ink. For example, after deposition of two or more inks, targeted photocuring of an interfacial region can be carried out to cure only a subset of the interfacial region, before remaining uncured inks surrounding the cured region are removed, prior to subsequent deposition to form additional layers of the 3D object. This approach can enhance the resolution of the multi-material cured component at interfacial regions between adjacent, dissimilar ink depositions.

For curing, exposure of the deposited ink to the photocuring light will typically cause portions of the ink with the least exposure to oxygen to cure first. When ink deposited onto the work surface, or onto a previously cured layer of the part being fabricated, is exposed to photocuring light, the lower-most portion of the deposited ink (i.e. that closest to the work surface or cured layer) will typically begin curing first. This is because the lower-most ink portion is shielded from oxygen to some degree, by the underlying work surface or cured layer. In this way, curing of portions of ink exposed to the photocuring light will typically proceed in the z-direction direction, starting at a level in the ink nearest the work surface and proceeding upwardly through the deposited ink, in a direction toward the light source (i.e. in a ‘bottom-up’ fashion). In general, when exposed to photocuring light, portions of deposited ink having the least amount of oxygen exposure will be caused to cure first. In some cases, where deposited ink is exposed to oxygen on multiple sides of the deposition, curing may commence at or near a central portion of the deposition, and proceed outwardly toward the edges of the deposition. For inks lacking sufficient oxygen resistance (e.g. acrylate-based inks), it may be that a ‘full cure’ through the thickness of the deposited ink is not possible under ambient atmospheric conditions, due to oxygen inhibition of exposed ink surfaces. In such cases, an upper-most portion of the deposited ink (in the z-direction) may not be fully cured, even when long curing times are employed.

In the following Examples the terms ‘ink’ and ‘resin’ are employed interchangeably.

### Improving Z-Resolution of the Printer

The z-resolution of the printer is dependent upon a range of factors, but most notably upon the layer thickness (i.e. the thickness of individual deposited and cured layers that compose the 3D object) and the curing depth (polymerisation depth) within each cured layer, during curing of the individual layers. The layer thickness can be dictated by varying the gap between the build platform 18 and the extrusion nozzle/s 32, 34 during deposition (i.e. the distance between the ink deposition arrangement 14 and the work surface 18, in the z-direction). The polymerisation depth can be dictated by properties of the ink used for printing e.g. a resin's optical transparency and oxygen resistance for example, but also can be controlled by selective application of the photopolymerising light. One of skill in the art will appreciate that the layer thickness is also dictated by the rheological properties of the inks being deposited, such as viscosity. Higher viscosity inks typically require the use of thicker deposition layers. In DIW-based deposition, more viscous inks generally require wider extrusion nozzles and larger deposition gaps. The layer thickness in each printer type can be further modified, e.g. by partially evaporating, wiping, or shrinking the deposited layer of ink.

The viscosity of a particular ink can be measured using a viscometer, by various methods known in the art. One of skill in the art will appreciate that viscosity measurements will be dependent upon the measurement conditions (e.g. temperature) under which they are conducted.

The optical transparency, polymerisation rate, and percentage polymerisation of a resin can be evaluated using spectroscopy techniques, such as UV-Vis spectroscopy and Fourier-transform infrared (FTIR) spectroscopy. The oxygen resistance of a resin can be evaluated by studying its rate and extent of polymerisation in oxygen-containing environments, using spectroscopy methods (as described above) or via empirical observations. The polymerisation depth is directly proportional to a resin's oxygen resistance, polymerisation rate, and optical transparency. It can also be empirically measured by studying the polymerisation of a thick resin layer with different exposure times under ambient or oxygen-containing conditions. Oxygen resistance and polymerisation rate of inks primarily depend upon their photo-polymerisation system (i.e. resin or ink type). However, a person of skill will appreciate that these properties can also be modulated using different additives and print conditions, as described above.

The oxygen resistance of the resin may be leveraged to improve the z-resolution of the 3D component, allowing control of the polymerization rate of the resin, thereby only partially curing the deposited layers through their thickness, in the z-direction (i.e. thereby reducing cured layer thickness). Where such partial z-direction curing is carried out, a lower cured portion of the resin is produced, leaving a remaining uncured portion on top, which may be removed (e.g. by mechanical wiping or chemical cleaning), prior to deposition of a following layer of fresh, uncured resin). Particularly for inks having high oxygen resistance, partial curing may be finely controlled by employing different exposure times of photocuring light. For example, a deposited ink layer of 100 μm thickness may be selectively cured to a depth of 50, 80, or 100 μm (i.e. to the full deposited thickness of the layer) as desired, by employing different exposure times.

The depth of cured and uncured sections may, in some embodiments, be modulated by varying the type of resin, the free radical scavenger concentration of the resin and the exposure time of the photocuring light for example, as illustrated in FIG. 9 (d) for the thiol-acrylate photocurable system.

### Cure Depth of Thiol-Acrylate-Based Resin

Here, resins were prepared with differing concentrations of tert-butylhydroquinone (TBHQ), a known free radical scavenger, ranging from no TBHQ addition to 0.8 parts w/w addition. The resins were prepared as printing inks by mixing 100 parts of (mercaptopropyl)methylsiloxane homopolymer and 100 parts of methacryloxypropyl terminated polydimethylsiloxane (each supplied by Gelest Inc., Morrisville, PA, USA) with 0.4 parts of phenylbis(2,4,6-trimethylbenzoyl) phosphine oxide (BAPO) and 0-0.8 parts of w/w tert-Butylhydroquinone (TBHQ) (each supplied by Sigma-Aldrich, Truganina, VIC, AU).

Each resin was deposited and cured at a temperature of approximately 20° C., in the presence of air. Approximately 160 μL of resin was deposited into a cylindrical mould having an internal diameter of 10 mm and a height of 2 mm. The mould was sprayed with a Teflon spray prior to deposition of the resin, to minimise adhesion. Within approximately 60 seconds of deposition, the resin was exposed to photocuring light. The curing depth was measured with a micrometer.

Each resin was exposed to photocuring light having a wavelength of 365 nm, for exposure times ranging from 60 seconds to 150 seconds. It was found that varying the concentration of TBHQ within the resins can significantly alter the curing depth of the resin for a given curing time (see FIG. 9 (d)). In FIG. 9 (d), the y-axis ‘Curing depth (%)’ refers to the percentage of deposited depth polymerised i.e. the percentage of the depth of the 160 μL of resin deposited into the cylindrical mould, that is cured.

### Thiol-Ene-, Thiol-Acrylate-, and Acrylate-Based Photocurable Systems

The curing depth of thiol-ene, thiol-acrylate, and acrylate-based photocurable systems, in the absence of TBHQ, was assessed at various curing times.

Three types of precursor resins were based on thiol-acrylate, acrylate, and thiol-ene chemistry, with a thiol-vinyl resin being selected as the example thiol-ene-based resin. The thiol-acrylate-based resin was prepared with (Mercaptopropyl)methylsiloxane homopolymer and methacryloxypropyl terminated polydimethylsiloxane. The thiol-ene-based resin was prepared with (Mercaptopropyl)methylsiloxane homopolymer and vinylmethoxysiloxane homopolymer. The acrylate-based resin was prepared with methacryloxypropyl terminated polydimethylsiloxane. Each resin was prepared with a photoinitiator (Phenylbis(2,4,6-trimethylbenzoyl) phosphine oxide (BAPO)) and a photo blocker (2,5-Bis (5-tert-butyl-benzoxazol-2-yl)thiophene (BBOT)). The resins were prepared and stored in amber glass vials under a nitrogen atmosphere to minimise exposure to ambient light and oxygen.

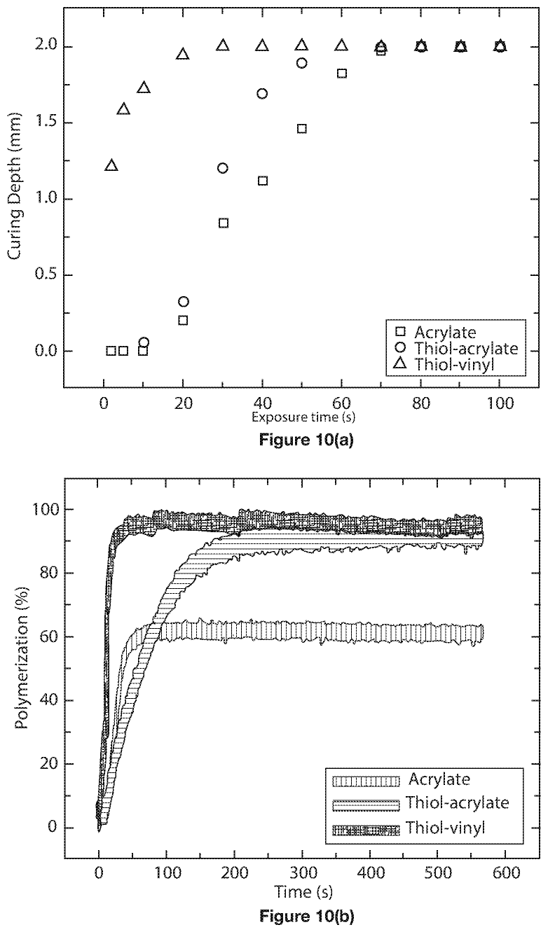

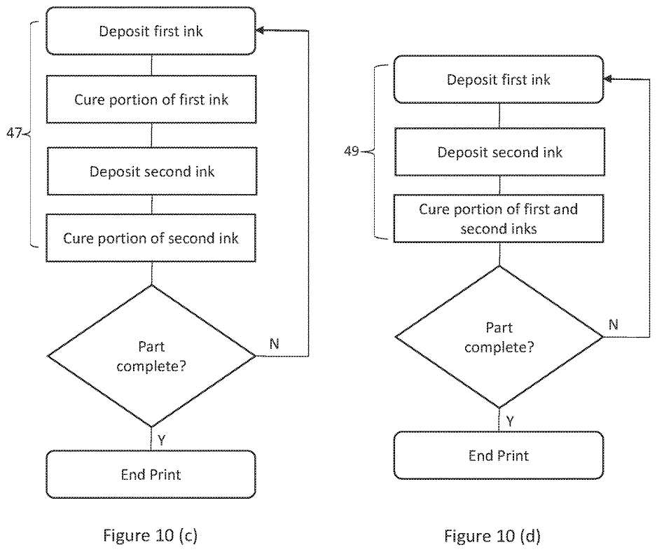

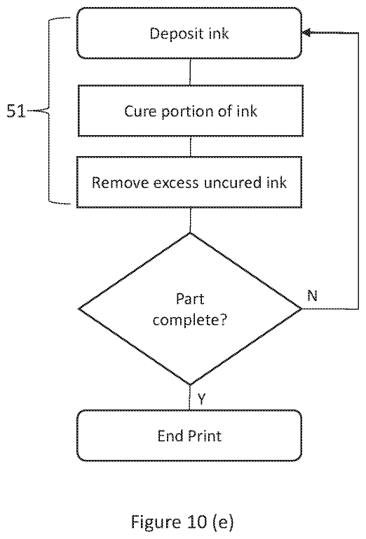

FIGS. 10 (a) and 10 (b) illustrate curing depth (in mm) and percentage of polymerisation (in this case, the percentage of conversion of monomer to polymer) respectively, for thiol-ene, thiol-acrylate, and acrylate-based photocurable systems at different curing times. Curing depth was determined using a micrometer, as outlined above.

Percentage of polymerisation was determined by real-time Fourier-transform infrared (RT-FTIR) spectroscopy during photocuring, in accordance with the methodology described above for studying photo-polymerisation reaction kinetics in reference to the assessment methodology for determining percentage polymerisation for an ink. Namely: Single Infrared spectra was acquired on a Bruker Vertex 70 Fourier transform infrared (FTIR) spectrometer using a single reflection Diamond ATR (Bruker Platinum) in the range of 3800-550 cm⁻¹ with a spectral resolution of 4 cm⁻¹. A volume of 5 μL of ink was pipetted onto the diamond ATR and 32 scans used for the sample measurements as well as background. The spectral resolution was set to 8 cm⁻¹ and the scanner velocity set to 160 kHz with a single sided acquisition mode. This resulted in an acquisition rate of 17.6 spectra per second by recording only the interferograms, for the duration of 10,000 acquisitions, approximately 9.45 minutes, per kinetic run. The kinetic run was started manually just prior to turning on the UV LED (photopolymerising light source) which is placed above the Diamond crystal. A monochromatic UV LED with a 3 mm focusing lens (with λₘₐₓ=405 nm and intensity of 20 mW/cm²) (Digi-Key electronics) was used for irradiating all samples, for approximately 9.45 minutes each. A basic electrical circuit was employed to power the LED, while monitoring the current to prevent any damage. An LED cover was provided to align the LED with the sample and to avoid samples being exposed to ambient light. The LED was positioned 3 mm above the ATR stage.

The samples exposed to the air during monitoring of the polymerisation reaction to assess the impact of oxygen inhibition on the photo-polymerisation kinetics. Assessments using this method are performed at 21° C. and under atmospheric conditions.

Post processing involved splitting the interferograms and creating spectra from the interferograms using the OPUS software (Version 8.1). The spectra were then integrated at the specified wavenumbers to plot peak area or intensity versus time.

The —CH═CH₂ bending and stretching peaks at ~939 cm⁻¹ and ~1637 cm⁻¹ were monitored to calculate the gelation time and percentage polymerisation, respectively. To assess thiol conversion (for inks containing thiol), the height of the —CH═CH₂ bending peak centred at 939 cm⁻¹ were be monitored over time as per Equation (1), where Xₜ is thiol conversion at time (t), A₀ is the initial absorbance, and Aₜ is the absorbance at the time (t).

$${X}_{t} = \frac{{A}_{θ} - {A}_{t}}{{A}_{0}} \qquad Equation ( 1 )$$

The peak area at ~1637 cm⁻¹ in the range of 1650-1620 cm⁻¹ was integrated at a subsequent time (t), and the percentage of polymerisation (%) at that time was calculated as per Equation (2):

$${P}_{t} = \frac{{A}_{0} - {A}_{t}}{{A}_{θ}} * 100 \qquad Equation ( 2 )$$

where Pₜ is the percentage polymerisation at time (t), A₀ is the initial absorbance, and Aₜ is the absorbance at the time (t).

FIG. 10 (a) shows a significant difference in the curing depth of thiol-acrylate- and acrylate-based resins during the first 60 seconds of exposure. The thiol-acrylate-based resin resulted in more controlled and rapid curing than the acrylate resin. The thiol-ene-based resin cured most rapidly and reached maximum curing depth within the first 45 seconds.

FIG. 10 (b) shows that the thiol-acrylate- and thiol-ene-based resins achieved close to 100% polymerization (in open atmosphere), whereas, the acrylate-based resin only achieved ca. 60% polymerisation.

It was found that acrylate-based inks have the slowest polymerisation rates and hence the smallest depth of polymerisation. In contrast, thiol-ene-based inks have the fastest rates of polymerisation and hence the highest polymerisation depths.

Additives known in the art such as photoblockers and photoinitiators (for example as described in International Patent Application Nos. PCT/AU2023/050159 and PCT/AU2023/050161, each of which are herein incorporated by reference in their entirety), as well as varying other print parameters, such as temperature and oxygen concentration at the deposition site, may be used to modify the polymerisation depth of the inks.

FIGS. 10 (c)-(e) illustrate schematic flow diagrams of various printing methods, according to embodiments of the present invention. FIG. 10 (c) illustrates the general procedure for printing a multi-material component, where the first ink is deposited and cured, before deposition and curing of the second ink. The combination of sequential steps 47 (i.e. deposition and curing of each ink) produce a single layer of the 3D component. The sequence of steps 47 can be repeated any number of times, in order to fabricate the desired 3D component, with subsequent layers built upon preceding layers, according to the geometry of the component to be printed.

FIG. 10 (d) illustrates an alternative method for printing a multi-material component, where each of the first and second inks for a given layer are deposited, prior to any curing or consolidation of the given layer. In this form, the first and second inks may be deposited sequentially or simultaneously over the work surface, as the work surface is moved relative to the ink deposition arrangement, to deposit the inks in the required x-y pattern (i.e. to conform with a layer of the 3D object to be printed).

FIG. 10 (e) illustrates a method of printing a single or multi-material component, where an intermediate cleaning step is employed after selective curing (e.g. curing to a particular height of the deposited ink), to remove substantially all uncured ink. This method may be particularly employed where a high degree of layer thickness control (i.e. in the z-direction of the print scheme) is required, for example in particularly complex parts requiring high print resolution, or for components to be fabricated of differing materials in the z-direction of the component. The removal of uncured ink exposes the underlying cured layer of the 3D component, which can then receive a further layer of deposited ink (e.g. of a different material type for example). This approach can provide higher resolution in the z-direction, by allowing for thinner cured layers. This may also allow for multiple material changes (in the case of multiple material printing) in close proximity to one another. i.e. finely spaced cured layers of first and second cured inks, having differing compositions.

The step of removing excess ink after a curing step may equally be employed in the methods illustrated in FIGS. 10 (c) and (d) and described above. Further, multiple different inks may be deposited in the method of FIG. 10 (e), in either a sequential or simultaneous fashion, as outlined above.

### EXAMPLES

### Example 1-Comparing the Resolution of Direct-Ink Writing-Based Printing and Hybrid Direct-Ink Writing and DLP-Based Printing

A resin was prepared as a printing ink by mixing 100 parts of (mercaptopropyl)methylsiloxane homopolymer and 100 parts of methacryloxypropyl terminated polydimethylsiloxane (each supplied by Gelest Inc., Morrisville, PA, USA) with 10 parts of polyethylene glycol 400, 0.9 parts of phenylbis(2,4,6-trimethylbenzoyl) phosphine oxide, 0.23 parts of 2,5-Bis (5-tert-butyl-benzoxazol-2-yl)thiophene, and 0.8 parts of w/w tert-Butylhydroquinone (TBHQ) (each supplied by Sigma-Aldrich, Truganina, VIC, AU). The resin components were mixed thoroughly on a vortex mixer and sonicator bath, and then the prepared resin was purged with nitrogen and vacuumed for an hour, followed by loading in the desired syringe of the ink deposition arrangement.

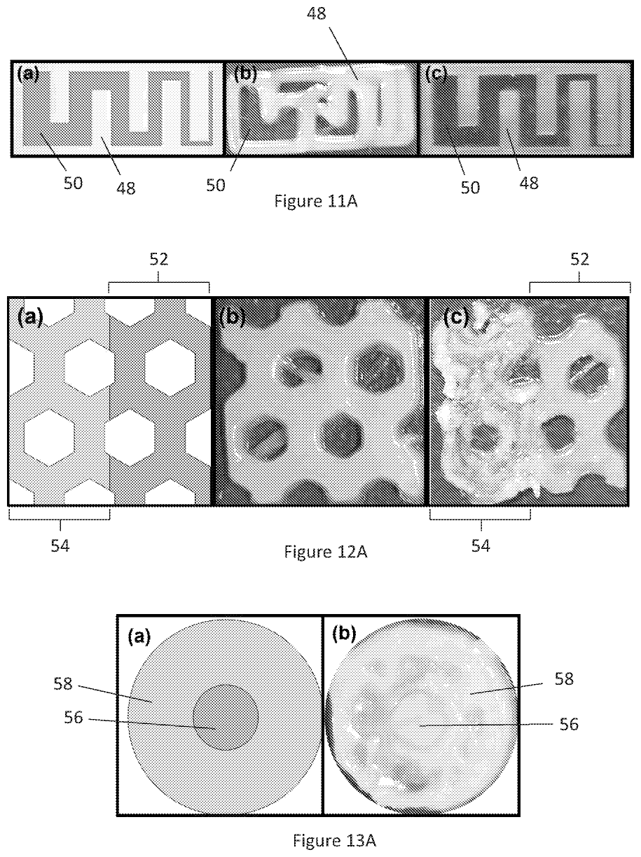

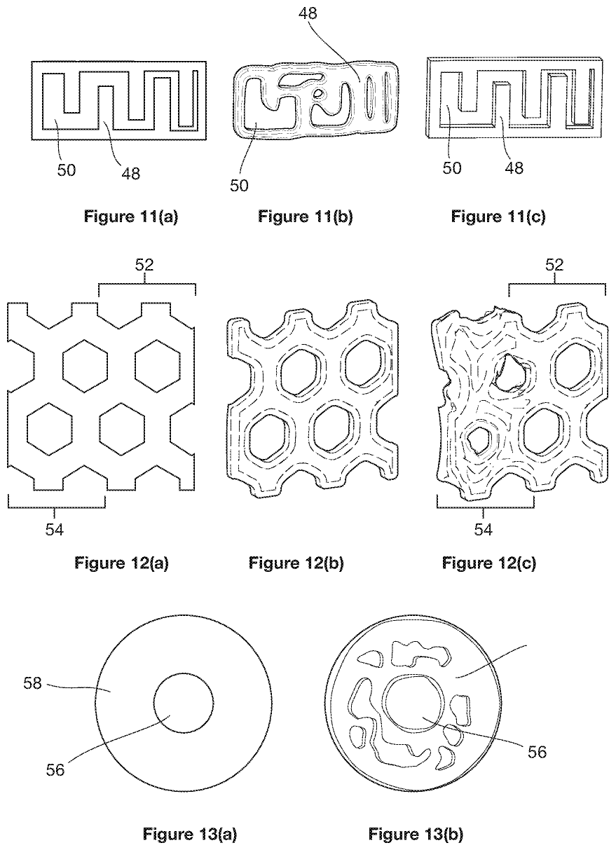

As illustrated in FIGS. 11 and 11A, the resin was extruded onto a work surface in a direct ink writing (DIW) process to form a pattern upon the work surface, as per the CAD model (FIGS. 11 (a) and 11A (a)) of a layer to be printed. The pattern comprised regions of resin 48 and voids 50 (i.e. an absence of resin), achieved by moving the work surface relative to the ink deposition arrangement during deposition of the resin.

The extruded resin pattern was then photopolymerised layer-by-layer, by exposing the entire work surface to a UV light having a wavelength of 405 nm, in line with conventional DIW-based 3D printing of photo-polymerisable resins. Each layer was approximately 100 μm thick, with a total of 10 layers deposited and cured to form the printed body. As shown in FIGS. 11 (b) and 11A (b), the resulting printed body exhibited poor resolution and definition of the intended design and its features, as compared with the CAD model of FIGS. 11 (a) and 11A (a). In particular, the edges of the component of FIGS. 11A (b) and 11 (b) were poorly defined, and not in good agreement with the geometry of the CAD model.

In contrast, when a like extruded resin pattern (again extruded as per the CAD model of FIGS. 11 (a) and 11A (a)) was instead selectively photopolymerised, by projecting a pattern of UV light (i.e. using a DLP process) in accordance with the CAD model onto the extruded resin, a significantly higher resolution and more accurate representation of the desired 3D part was achieved, as illustrated in FIGS. 11 (c) and 11A (c). In particular, the component illustrated in FIG. 11 (c) exhibits well defined edges, which are in good agreement with the CAD model.

Thus, by projecting a selective pattern of photocuring light onto a selectively deposited resin, itself having an initial deposited geometry, a higher-resolution, more accurate representation of the desired final component may be achieved. This example illustrates the advantages of a hybrid DIW/DLP process, according to the present disclosure.

### Example 2-3D Printing of a Multi-Material Object with Two Different Materials Adjacent One Another

Two different resins were prepared, termed Resin 1 and Resin 2. Resin 1 was prepared by mixing 100 parts of (mercaptopropyl)methylsiloxane homopolymer and 100 parts of methacryloxypropyl terminated polydimethylsiloxane (each supplied by Gelest Inc., Morrisville, PA, USA) with 10 parts of polyethylene glycol 400, 0.9 parts of phenylbis (2,4,6-trimethylbenzoyl) phosphine oxide, 0.23 parts of 2,5-Bis (5-tert-butyl-benzoxazol-2-yl)thiophene, and 0.8 parts of w/w tert-butylhydroquinone (TBHQ) (each supplied by Sigma-Aldrich, Truganina, VIC, AU). The components for Resin 1 were mixed thoroughly on a vortex mixer and sonicator bath, followed by purging the prepared resin with nitrogen. The purged resin was then vacuumed for one hour, followed by loading in Syringe 1 of the ink deposition arrangement. Resin 2 was prepared by mixing 100 parts of (mercaptopropyl)methylsiloxane homopolymer and 100 parts of methacryloxypropyl terminated polydimethylsiloxane (each supplied by Gelest Inc., Morrisville, PA, USA), with 0.9 parts of phenylbis(2,4,6-trimethylbenzoyl) phosphine oxide, 0.23 parts of 2,5-bis(5-tert-butyl-benzoxazol-2-yl)thiophene, and 0.8 parts of w/w tert-butylhydroquinone (TBHQ) (each supplied by Sigma-Aldrich, Truganina, VIC, AU). The components for Resin 2 were mixed thoroughly on a vortex mixer and sonicator bath, and then the prepared resin was purged with nitrogen and vacuumed for an hour, followed by loading in Syringe 2 of the ink deposition arrangement.

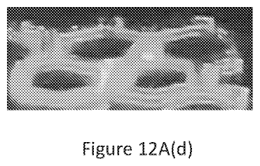

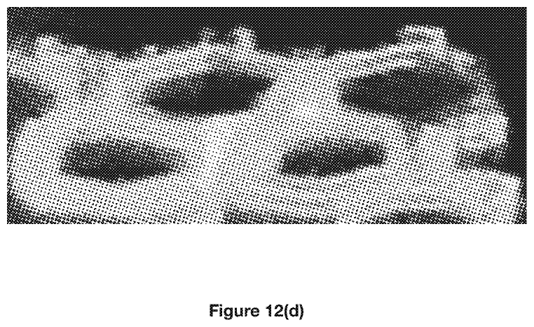

A honeycomb pattern (as shown in FIGS. 12 (a) and 12A (a) in CAD representation) was 3D printed with single and multiple materials.

### Single Material Printing

A single material version of the honeycomb structure was printed with Resin 1 only, using sequential layer deposition and selective photocuring as described above. In particular, a DIW process was undertaken to deposit a layer of Resin 1 in an initial geometry according to FIGS. 12 (a) and 12A (a), followed by projection of a photocuring pattern according to FIGS. 12 (a) and 12A (a) upon the deposited resin to selectively photocure the deposited resin (i.e. in a DLP process). Additional like layer depositions and selective photocuring processes were undertaken, in order to build up the 3D component layer-by-layer (again, 10 layers of approximately 100 μm thickness each) to the required height, producing a consolidated 3D component (FIGS. 12 (b) and 12A (b)) in good agreement with the initial CAD model (FIGS. 12 (a) and 12A (a)).

### Multi-Material Printing

A multi-material version of the honeycomb structure was printed by dividing the honeycomb model into a first 52 and a second 54 section, as shown in FIGS. 12 (a) and 12A (a). The right-hand section 52 was printed with Resin 1, and the left-hand section 54 was printed with Resin 2. The two materials were extruded individually per their respective CAD designs, and each extruded layer was selectively photopolymerised by projecting photocuring light upon each extruded layer (shown by FIGS. 12 (d) and 12A (d)) in respective patterns, according to the CAD design. The process resulted in the printing of a 3D honeycomb structure with two different materials incorporated within each layer and placed adjacent to each other, as shown in FIGS. 12 (c) and 12A (c).

### Example 3-3D Printing of a Multi-Material Object with Two Different Materials in a Concentric Configuration

Two different resins were prepared, termed Resin 1 and Resin 2. Resin 1 was prepared by mixing 100 parts of (mercaptopropyl)methylsiloxane homopolymer and 100 parts of methacryloxypropyl terminated polydimethylsiloxane (each supplied by Gelest Inc., Morrisville, PA, USA) with 10 parts of polyethylene glycol 400, 0.9 parts of phenylbis (2,4,6-trimethylbenzoyl) phosphine oxide, 0.23 parts of 2,5-bis(5-tert-butyl-benzoxazol-2-yl)thiophene, and 0.8 parts of w/w tert-butylhydroquinone (TBHQ) (each supplied by Sigma-Aldrich, Truganina, VIC, AU). The resin components were mixed thoroughly on a vortex mixer and sonicator bath, and then the prepared resin was purged with nitrogen and vacuumed for an hour, followed by loading in Syringe 1 of the ink deposition arrangement. Resin 2 was prepared by mixing 100 parts of (mercaptopropyl)methylsiloxane homopolymer and 100 parts of methacryloxypropyl terminated polydimethylsiloxane (each supplied by Gelest Inc., Morrisville, PA, USA) with 0.9 parts of phenylbis(2,4,6-trimethylbenzoyl) phosphine oxide, 0.23 parts of 2,5-bis(5-tert-butyl-benzoxazol-2-yl)thiophene, and 0.8 parts of w/w tert-butylhydroquinone (TBHQ) (each supplied by Sigma-Aldrich, Truganina, VIC, AU). The resin components were mixed thoroughly on a vortex mixer and sonicator bath, and then the prepared resin was purged with nitrogen and vacuumed for an hour, followed by loading in Syringe 2 of the ink deposition arrangement.

The two materials were extruded individually per their respective designs shown in FIGS. 13 (a) and 13A (a), where the CAD model comprised a first 56 and a second 58 section. Resin 1 was extruded in a geometry corresponding to the first section 56, while Resin 2 was extruded in a geometry corresponding to the second section 58.

Each extruded layer comprising Resins 1 and 2 was selectively photopolymerised, layer-by layer, by projecting photocuring light in respective patterns corresponding to the geometry of the first and second sections. The process resulted in the printing of a multi-material object where each layer was composed of two different materials located concentric to each other, to form a single 3D component as shown in FIGS. 13 (b) and 13A (b).

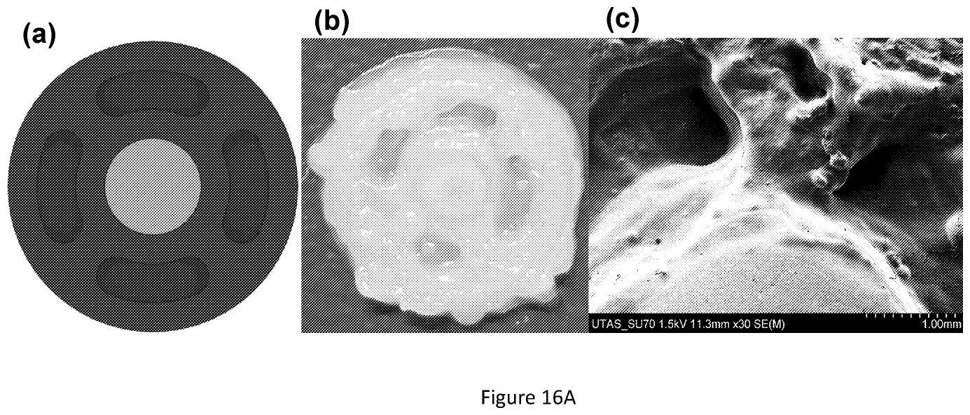

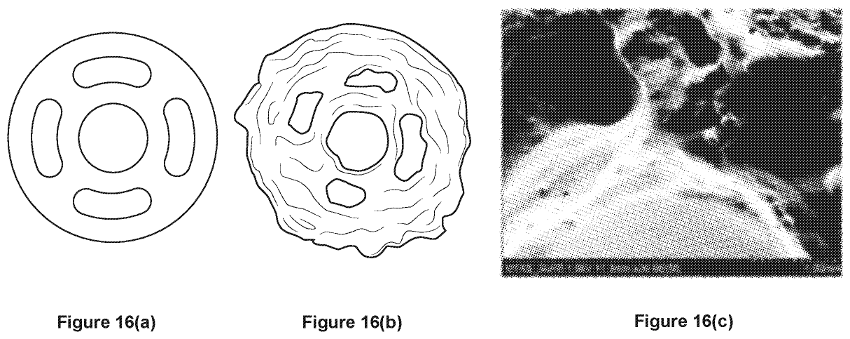

A further pair of materials were extruded individually per their respective designs shown in FIGS. 16 (a) and 16A (a), where the CAD model comprised a first (inner) and a second (outer) section. Resin 1 was extruded in a geometry corresponding to the first (inner) section, while Resin 2 was extruded in a geometry corresponding to the second (outer) section.

Each extruded layer comprising Resins 1 and 2 was selectively photopolymerised, layer-by layer, by projecting photocuring light in respective patterns corresponding to the geometry of the first and second sections. The process resulted in the printing of a multi-material object where each layer was composed of two different materials located concentric to each other, to form a single 3D component as shown in FIGS. 16 (b) and 16A (b). FIGS. 16 (c) and 16A (c) show an SEM image of a portion of FIGS. 16 (b) and 16A (b).

### Example 4-3D Printing of a Silicon Oxycarbide Microneedle Array with the Base and Needles of Different Porosity

Two different resins were prepared, termed “Resin 1” and “Resin 2”, for the printing of a microneedle array having a base portion provided with a number of needles-shaped structures.

Resin 1 was prepared by mixing 100 parts of (mercaptopropyl)methylsiloxane homopolymer (supplied by Gelest Inc., Morrisville, PA, USA) and 32.6 parts of polyethylene glycol diacrylate (M.W of 250) with 20 parts of mesoporous silica particles (5-10 nm diameter), 0.9 parts of phenylbis(2,4,6-trimethylbenzoyl) phosphine oxide, 0.46 parts of 2-nitrophenyl phenyl sulfide, and 0.8 parts of w/w tert-butylhydroquinone (TBHQ) (each supplied by Sigma-Aldrich, Truganina, VIC, AU). The resin components were mixed thoroughly on a vortex mixer and sonicator bath, and then the prepared resin was purged with nitrogen and vacuumed for an hour, followed by loading in Syringe 1 of the ink deposition arrangement. Resin 2 was prepared by mixing 100 parts of (mercaptopropyl)methylsiloxane homopolymer (supplied by Gelest Inc., Morrisville, PA, USA) and 32.6 parts of polyethylene glycol diacrylate (M.W of 250) with 4 parts of silica particles (5-10 nm diameter), 0.9 parts of phenylbis(2,4,6-trimethylbenzoyl) phosphine oxide, 0.46 parts of 2-nitrophenyl phenyl sulfide, and 0.8 parts of w/w tert-butylhydroquinone (TBHQ) (each supplied by Sigma-Aldrich, Truganina, VIC, AU). The resin components were mixed thoroughly on a vortex mixer and sonicator bath, and then the prepared resin was purged with nitrogen and vacuumed for an hour, followed by loading in Syringe 2 of the ink deposition arrangement.

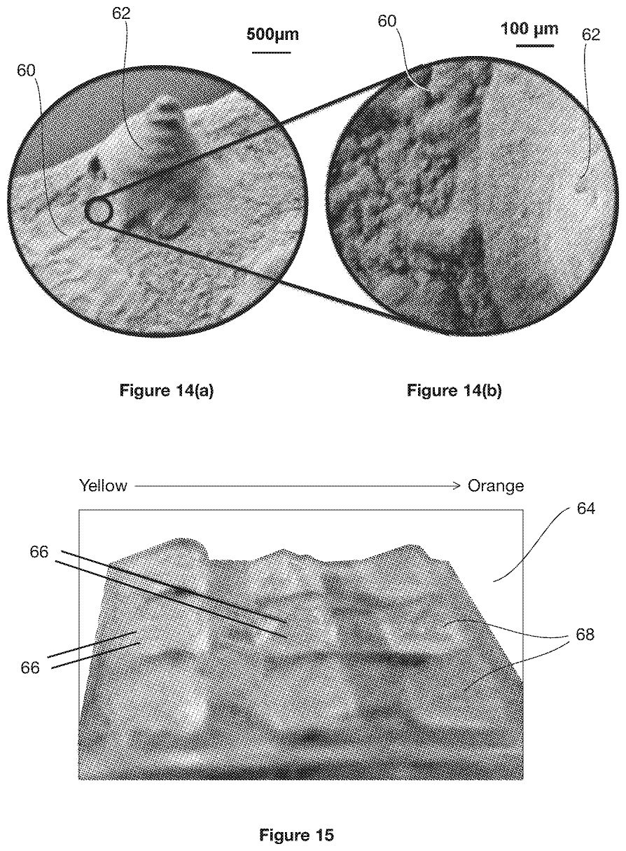

As illustrated in FIGS. 14 (a), 14A (a) and 14 (b), 14A (b), Resin 1 was used to print the base portion 60 and Resin 2 was used to print the microneedles 62, by interchanging actuation of the syringes as and when required, while selectively depositing the resin as per their CAD model. The array was printed with 30 layers of 100 μm thickness each, with deposited ink layers selectively exposed to 405 nm photocuring light for 20 minutes, to consolidate the layers. The printed array was pyrolysed under vacuum in a tube furnace. The pyrolysis was performed with a ramp rate of 1° C./min from 25° C. to 100° C., followed by 0.5° C./min from 100° C. to 600° C. The furnace was held at 600° C. for 180 minutes. The furnace was then cooled from 600° C. to 450° C. and then to 300° C. at a ramp rate of 2° C./min. The furnace was held at 450° C. and 300° C. for 60 minutes each. It was finally cooled to 25° C. at a ramp rate of 2° C./min to produce silicon oxycarbide microneedle arrays. The use of Resin 1 resulted in a highly porous silicon oxycarbide base 60, and the use of Resin 2 resulted in medium porosity silicon oxycarbide microneedles 62 as illustrated in FIGS. 14 (a), 14A (a) and 14 (b), 14A (b). The resin properties and pyrolysis conditions were optimised such that no delamination was observed between the two materials during printing or pyrolysis.

### Example 5-3D Printing of a Microneedle Array with a Colour Gradient in the x, y, and z-Direction

Two different resins were prepared, termed Resin 1 and Resin 2. Resin 1 was prepared by mixing 100 parts of (mercaptopropyl)methylsiloxane homopolymer (supplied by Gelest Inc., Morrisville, PA, USA) and 32.6 parts of polyethylene glycol diacrylate (M.W of 250) with 4 parts of silica particles (5-10 nm diameter), 0.9 parts of phenylbis (2,4,6-trimethylbenzoyl) phosphine oxide, 0.46 parts of 2-nitrophenyl phenyl sulfide, and 0.8 parts of w/w tert-butylhydroquinone (TBHQ) (each supplied by Sigma-Aldrich, Truganina, VIC, AU). The resin components were mixed thoroughly on a vortex mixer and sonicator bath, and then the prepared resin was purged with nitrogen and vacuumed for an hour, followed by loading in Syringe 1 of the ink deposition arrangement. Resin 2 was prepared by mixing 100 parts of (mercaptopropyl)methylsiloxane homopolymer (supplied by Gelest Inc., Morrisville, PA, USA) and 32.6 parts of polyethylene glycol diacrylate (M.W of 250) with 20 parts of mesoporous silica particles (5-10 nm diameter), 0.9 parts of phenylbis(2,4,6-trimethylbenzoyl) phosphine oxide, 0.05 parts of Sudan I, and 0.8 parts of w/w tert-butylhydroquinone (TBHQ) (each supplied by Sigma-Aldrich, Truganina, VIC, AU). The resin components were mixed thoroughly on a vortex mixer and sonicator bath, and then the prepared resin was purged with nitrogen and vacuumed for an hour, followed by loading in Syringe 2 of the ink deposition arrangement.

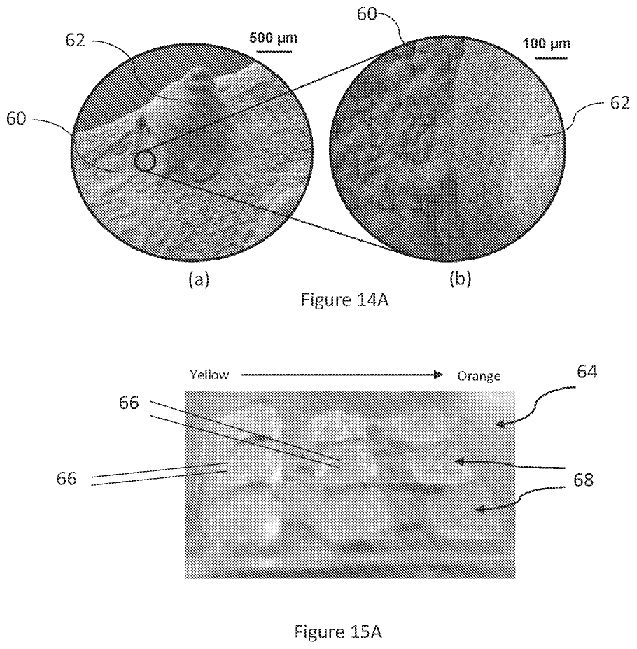

Resin 1 exhibited a light-yellow colour, while Resin 2 exhibited an orange colour. The two resins were used to print a microneedle array 64 with a colour gradient of light yellow to bright orange as shown in FIGS. 15 and 15A. This was achieved by interchanging between actuating each syringe containing Resin 1 and Resin 2 in the x, y, and z-direction, as the resin was deposited layer-by-layer to roughly trace the microneedle geometry, followed by photocuring to obtain the required resolution, as observed by the sharpness of the individual layers 66 of the needles 68. The array was printed with 30 layers of 100 μm each.

### Example 6-3D Printing of an Electro-Osmotic Pump with Different Core and Encapsulating Materials

Two different resins, termed “Resin 1” and “Resin 2,” were prepared for the printing of an electro-osmotic pump with a silicon oxycarbide-based core and a silica-based encapsulation.

Resin 1 was prepared by mixing 100 parts of (mercaptopropyl)methylsiloxane homopolymer (supplied by Gelest Inc., Morrisville, PA, USA) and 70 parts of vinylmethoxysiloxane homopolymer (supplied by Gelest Inc., Morrisville, PA, USA) with 6 parts of silica particles (5-10 nm diameter), 0.9 parts of phenylbis(2,4,6-trimethylbenzoyl) phosphine oxide, 0.46 parts of 2-nitrophenyl phenyl sulfide, and 0.8 parts of w/w tert-butylhydroquinone (TBHQ) (each supplied by Sigma-Aldrich, Truganina, VIC, AU). The resin components were mixed thoroughly on a vortex mixer and sonicator bath, and then the prepared resin was purged with nitrogen and vacuumed for an hour, followed by loading in Syringe 1 of the ink deposition arrangement. Resin 2 was prepared by mixing 100 parts of (mercaptopropyl)methylsiloxane homopolymer (supplied by Gelest Inc., Morrisville, PA, USA) and 32.6 parts of polyethylene glycol diacrylate (M.W of 250) with 20 parts of mesoporous silica particles (5-10 nm diameter), 0.9 parts of phenylbis(2,4,6-trimethylbenzoyl) phosphine oxide, 0.46 parts of 2-nitrophenyl phenyl sulfide, and 0.8 parts of w/w tert-butylhydroquinone (TBHQ) (each supplied by Sigma-Aldrich, Truganina, VIC, AU). The resin components were mixed thoroughly on a vortex mixer and sonicator bath, and then the prepared resin was purged with nitrogen and vacuumed for an hour, followed by loading in Syringe 2 of the ink deposition arrangement.

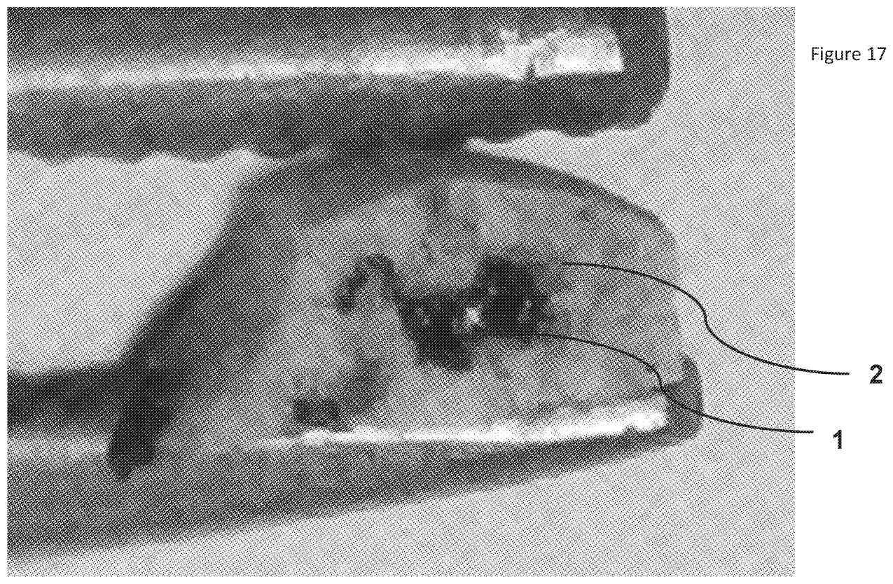

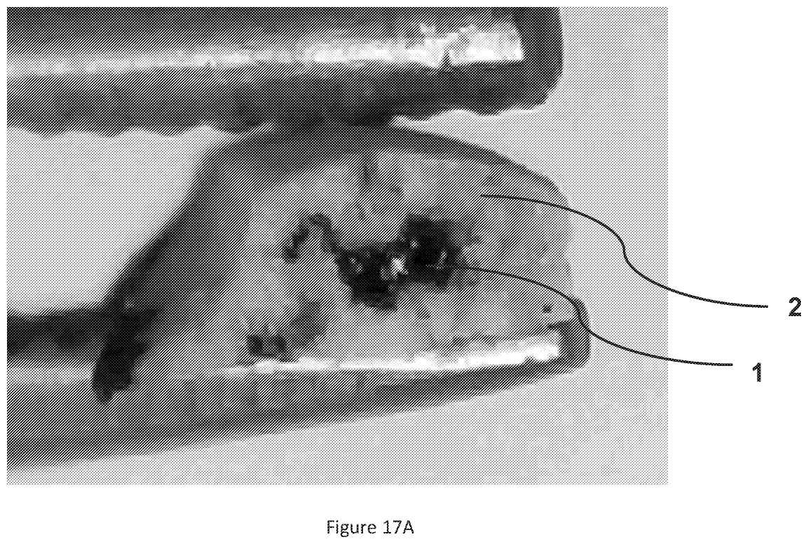

Resin 1 resulted in a black hydrophobic silicon oxycarbide-based core and Resin 2 resulted in a white hydrophilic silica-based encapsulation as shown in FIGS. 17 and 17A (Resins 1 and 2 denoted by reference numerals 1 and 2 respectively). This was achieved by interchanging between actuating each syringe containing Resin 1 and Resin 2 in the x, y, and z-direction, as the resin was deposited layer-by-layer to roughly trace the core and encapsulating layer geometries, followed by photocuring to obtain the required resolution.

### Example 7-3D Printing of a Circular Microneedle Array with Different Base and Microneedle Materials

Two different resins were prepared, termed Resin 1 and Resin 2. Resin 1 was prepared by mixing 100 parts of (mercaptopropyl)methylsiloxane homopolymer (supplied by Gelest Inc., Morrisville, PA, USA) and 32.6 parts of polyethylene glycol diacrylate (M.W of 250) with 4 parts of silica particles (5-10 nm diameter), 0.9 parts of phenylbis (2,4,6-trimethylbenzoyl) phosphine oxide, 0.46 parts of 2-nitrophenyl phenyl sulfide, and 0.8 parts of w/w tert-butylhydroquinone (TBHQ) (each supplied by Sigma-Aldrich, Truganina, VIC, AU). The resin components were mixed thoroughly on a vortex mixer and sonicator bath, and then the prepared resin was purged with nitrogen and vacuumed for an hour, followed by loading in Syringe 1 of the ink deposition arrangement. Resin 2 was prepared by mixing 100 parts of (mercaptopropyl)methylsiloxane homopolymer (supplied by Gelest Inc., Morrisville, PA, USA) and 32.6 parts of polyethylene glycol diacrylate (M.W of 250) with 20 parts of silica mesoporous particles (5-10 nm diameter), 0.9 parts of phenylbis(2,4,6-trimethylbenzoyl) phosphine oxide, 0.46 parts of 2-nitrophenyl phenyl sulfide, and 0.8 parts of w/w tert-butylhydroquinone (TBHQ) (each supplied by Sigma-Aldrich, Truganina, VIC, AU). The resin components were mixed thoroughly on a vortex mixer and sonicator bath, and then the prepared resin was purged with nitrogen and vacuumed for an hour, followed by loading in Syringe 2 of the ink deposition arrangement.

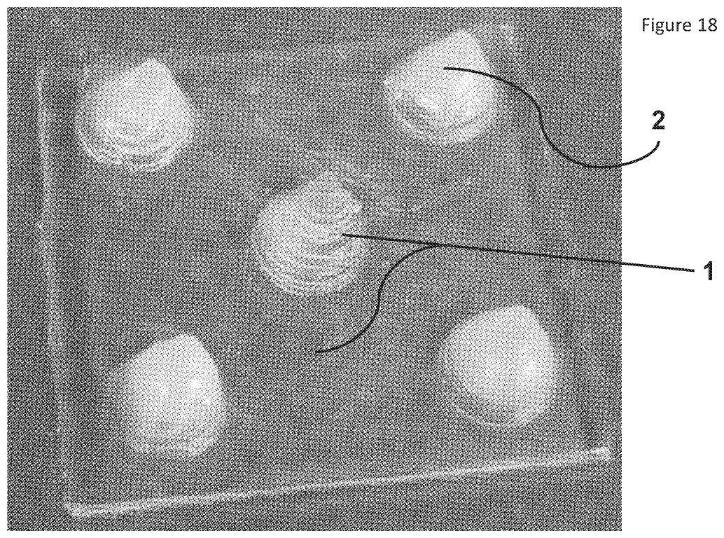

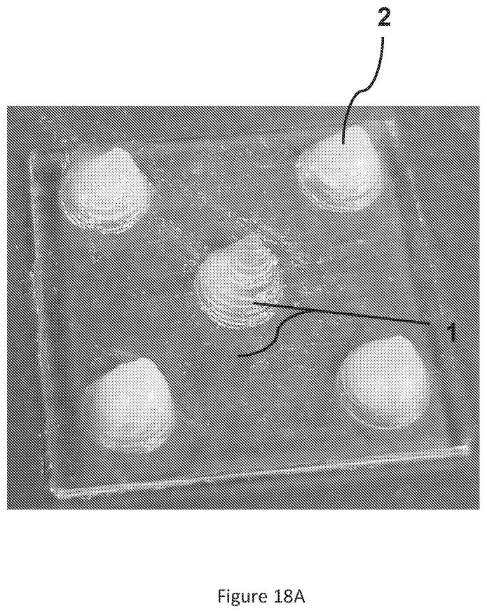

Resin 1 resulted in transparent layers, while Resin 2 resulted in translucent layers. The two resins were used to print a microneedle array with a transparent base and opaque microneedles, as shown in FIGS. 18 and 18A (Resins 1 and 2 denoted by reference numerals 1 and 2 respectively). This was achieved by interchanging between actuating each syringe containing Resin 1 and Resin 2 in the x, y, and z-direction, as the resin was deposited layer-by-layer to roughly trace the microneedle geometry, followed by photocuring to obtain the required resolution, as observed by the sharpness of the individual layers of the needles. The array was printed with 30 layers of 100 μm each.

### Example 8-3D Printing of a Rectangular Pyramid Array with Different Materials for Different Microneedles

Two different resins were prepared, termed Resin 1 and Resin 2. Resin 1 was prepared by mixing 100 parts of (mercaptopropyl)methylsiloxane homopolymer (supplied by Gelest Inc., Morrisville, PA, USA) and 32.6 parts of polyethylene glycol diacrylate (M.W of 250) with 4 parts of silica particles (5-10 nm diameter), 0.9 parts of phenylbis (2,4,6-trimethylbenzoyl) phosphine oxide, 0.46 parts of 2-nitrophenyl phenyl sulfide, and 0.8 parts of w/w tert-butylhydroquinone (TBHQ) (each supplied by Sigma-Aldrich, Truganina, VIC, AU). The resin components were mixed thoroughly on a vortex mixer and sonicator bath, and then the prepared resin was purged with nitrogen and vacuumed for an hour, followed by loading in Syringe 1 of the ink deposition arrangement. Resin 2 was prepared by mixing 100 parts of (mercaptopropyl)methylsiloxane homopolymer (supplied by Gelest Inc., Morrisville, PA, USA) and 32.6 parts of polyethylene glycol diacrylate (M.W of 250) with 20 parts of silica mesoporous particles (5-10 nm diameter), 0.9 parts of phenylbis(2,4,6-trimethylbenzoyl) phosphine oxide, 0.46 parts of 2-nitrophenyl phenyl sulfide, and 0.8 parts of w/w tert-butylhydroquinone (TBHQ) (each supplied by Sigma-Aldrich, Truganina, VIC, AU). The resin components were mixed thoroughly on a vortex mixer and sonicator bath, and then the prepared resin was purged with nitrogen and vacuumed for an hour, followed by loading in Syringe 2 of the ink deposition arrangement.

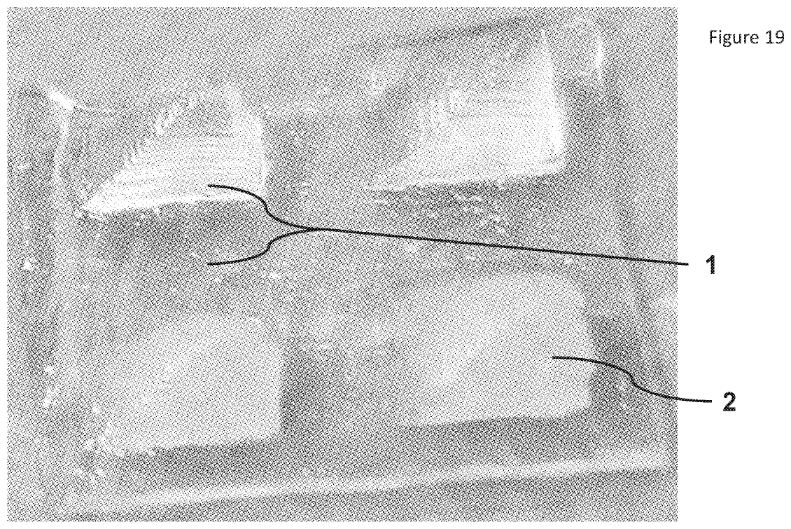

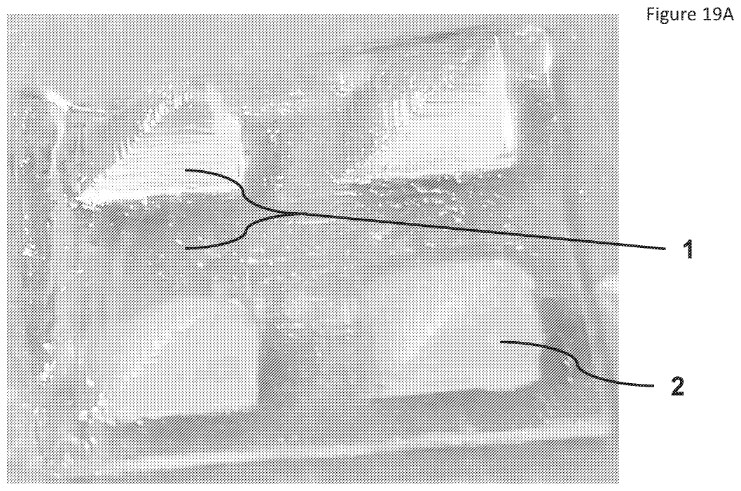

Resin 1 exhibited a light-yellow colour (less opaque), while Resin 2 exhibited a dark-yellow colour (more opaque) as shown in FIGS. 19 and 19A (Resins 1 and 2 denoted by reference numerals 1 and 2 respectively). This was achieved by interchanging between actuating each syringe containing Resin 1 and Resin 2 in the x, y, and z-direction, as the resin was deposited layer-by-layer to roughly trace the microneedle geometry, followed by photocuring to obtain the required resolution, as observed by the sharpness of the individual layers of the needles. The array was printed with 30 layers of 100 μm each.

### Example 9-3D Printing a Test Piece with One Material Encapsulating Another Material

Two different resins were prepared, termed Resin 1 and Resin 2. Resin 1 was prepared by mixing 100 parts of (mercaptopropyl)methylsiloxane homopolymer (supplied by Gelest Inc., Morrisville, PA, USA) and 70 parts of vinylmethoxysiloxane homopolymer (supplied by Gelest Inc., Morrisville, PA, USA) with 6 parts of silica particles (5-10 nm diameter), 0.9 parts of phenylbis(2,4,6-trimethylbenzoyl) phosphine oxide, 0.05 parts of Sudan I, and 0.8 parts of w/w tert-butylhydroquinone (TBHQ) (each supplied by Sigma-Aldrich, Truganina, VIC, AU). The resin components were mixed thoroughly on a vortex mixer and sonicator bath, and then the prepared resin was purged with nitrogen and vacuumed for an hour, followed by loading in Syringe 1 of the ink deposition arrangement. Resin 2 was prepared by mixing 100 parts of (mercaptopropyl)methylsiloxane homopolymer (supplied by Gelest Inc., Morrisville, PA, USA) and 37.6 parts of 3-Butyn-1-ol (a thiol-yne former), with 20 parts of silica mesoporous particles (5-10 nm diameter), 0.9 parts of phenylbis(2,4,6-trimethylbenzoyl) phosphine oxide, 0.46 parts of 2-nitrophenyl phenyl sulfide, and 0.8 parts of w/w tert-butylhydroquinone (TBHQ) (each supplied by Sigma-Aldrich, Truganina, VIC, AU). The resin components were mixed thoroughly on a vortex mixer and sonicator bath, and then the prepared resin was purged with nitrogen and vacuumed for an hour, followed by loading in Syringe 2 of the ink deposition arrangement.

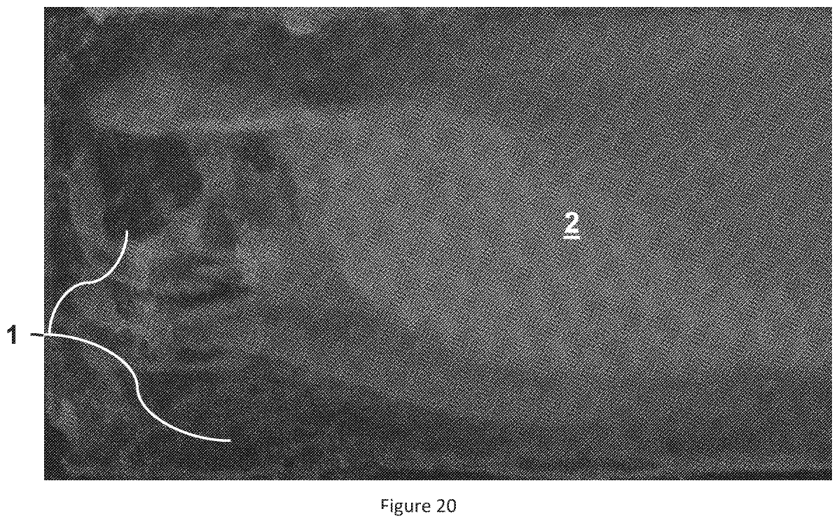

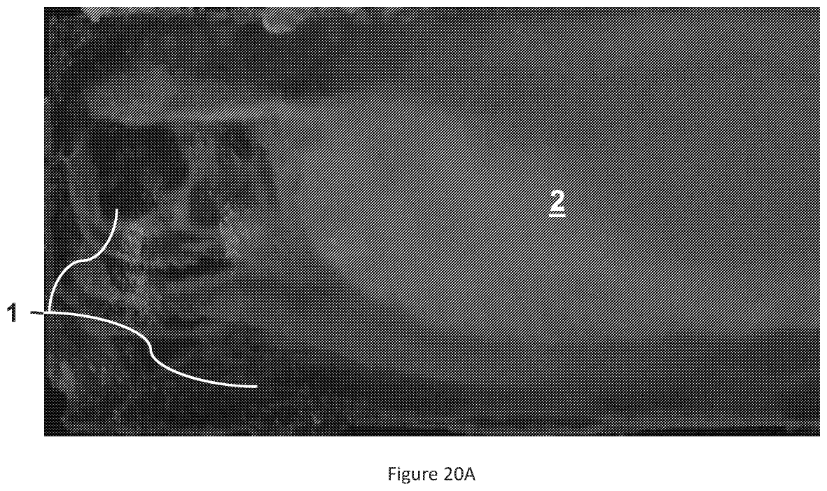

Resin 1 resulted in transparent layers, while Resin 2 resulted in translucent layers as shown in FIGS. 20 and 20A (Resins 1 and 2 denoted by reference numerals 1 and 2 respectively). This was achieved by interchanging between actuating each syringe containing Resin 1 and Resin 2 in the x, y, and z-direction, as the resin was deposited layer-by-layer to roughly trace each layer geometry, followed by photocuring to obtain the required resolution. The array was printed with 20 layers of 100 μm each.

### Example 10—General Formulae of Exemplary Ink Systems for 3D Printing

A general summary of suitable ink classes and common monomers for 3D printing according to the present disclosure, are given, respectively, in Table 1 and Table 2 below.

TABLE 1
Suitable resin systems for 3D printing.

| Resin Class | Chemical Backbone |
|---|---|
| 1. Thiol-acrylate | Thio-based monomers with a general formula as below. R¹ can be potentially any organic or |
| based resins | inorganic backbone. |
| | R¹—SH |
| | Acrylated-based monomers with a general formula as below. R² can be potentially any organic or |
| | inorganic backbone. |
| | 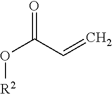 |
| 2. Thiol-ene | Thiol-based monomers with a general formula as below. R¹ can be potentially any organic or |
| based resins | inorganic backbone. |
| | R¹—SH |
| | Ene-based monomers with a general formula as below. R³ can be potentially any organic or inorganic |
| | backbone. |
| | 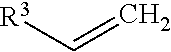 |
| 3. Thiol-yne | Thiol-based monomers with a general formula as below. R¹ can be potentially any organic or |
| based resins | inorganic backbone. |
| | R¹—SH |
| | Yne-based monomers with a general formula as below. R⁴ can be potentially any organic or inorganic |
| | backbone. |
| | R⁴—≡CH |
| 4. Thiol-ene- | Thiol-based monomers with a general formula as below. R¹ can be potentially any organic or |
| acrylate based | inorganic backbone. |
| resins | R¹—SH |
| | Ene-based monomers with a general formula as below. R³ can be potentially any organic or inorganic |
| | backbone. |
| | 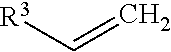 |
| | Acrylate-based monomers with a general formula as below. R² can be potentially any organic or |
| | inorganic backbone. |
| | 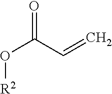 |
| 5. Thiol-yne- | Thio-based monomers with a general formula as below. R¹ can be potentially any organic or |
| acrylate based | inorganic backbone. |
| resins | R¹—SH |
| | Yne-based monomers with a general formula as below. R⁴ can be potentially any organic or inorganic |
| | backbone. |
| | R⁴—≡CH |
| | Acrylate-based monomers with a general formula as below. R² can be potentially any organic or |
| | inorganic backbone. |
| | 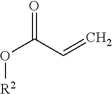 |

TABLE 2
Common monomers for the production of resin inks.

| Monomer Class | Common Monomers |
|---|---|
| 1. Thiol-based monomers | 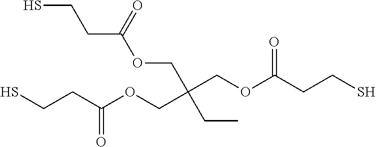 [SMILES: CCC(COC(=O)CCS)(COC(=O)CCS)COC(=O)CCS] |
| | TMPMP |
| | 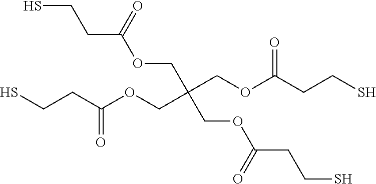 [SMILES: O=C(CCS)OCC(COC(=O)CCS)(COC(=O)CCS)COC(=O)CCS] |
| | PETMP |
| | 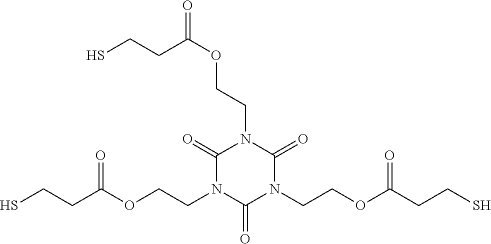 [SMILES: O=C(CCS)OCCn1c(=O)n(CCOC(=O)CCS)c(=O)n(CCOC(=O)CCS)c1=O] |
| | TMI |
| | 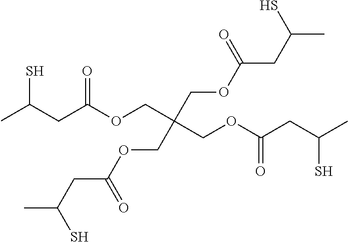 [SMILES: CC(S)CC(=O)OCC(COC(=O)CC(C)S)(COC(=O)CC(C)S)COC(=O)CC(C)S] |
| | PE-1 |
| 2. Acrylate-based Monomers | 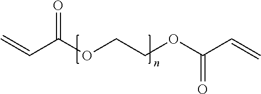 |
| | PEGDA |
| | 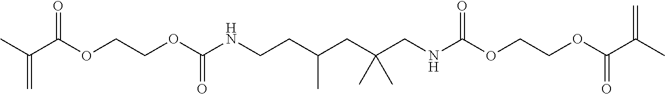 [SMILES: C=C(C)C(=O)OCCOC(=O)NCCC(C)CC(C)(C)CNC(=O)OCCOC(=O)C(=C)C] |
| | UDMA |
| | 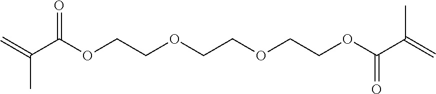 [SMILES: C=C(C)C(=O)OCCOCCOCCOC(=O)C(=C)C] |
| | TEGDMA |
| | 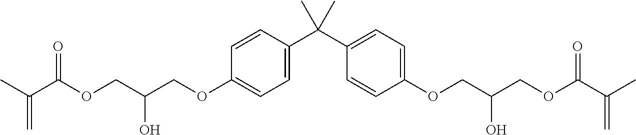 [SMILES: C=C(C)C(=O)OCC(O)COc1ccc(C(C)(C)c2ccc(OCC(O)COC(=O)C(=C)C)cc2)cc1] |
| | Bis-GMA |
| | 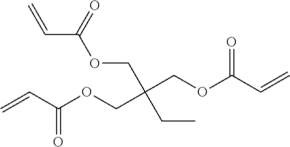 [SMILES: C=CC(=O)OCC(CC)(COC(=O)C=C)COC(=O)C=C] |
| | TTA |
| | 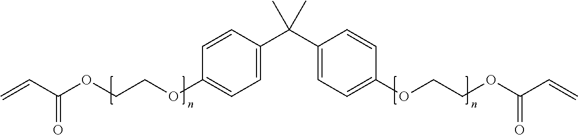 |
| | Bis-EDA |
| 3. Ene/Yne-based monomers | 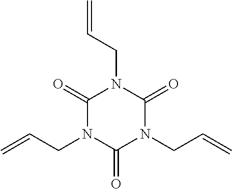 [SMILES: C=CCn1c(=O)n(CC=C)c(=O)n(CC=C)c1=O] |
| | TTT |
| | 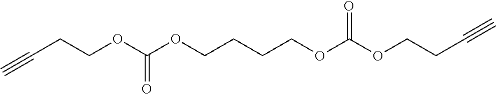 [SMILES: C#CCCOC(=O)OCCCCOC(=O)OCCC#C] |
| | 4MPC |
| | 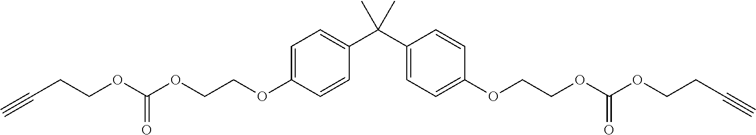 [SMILES: C#CCCOC(=O)OCCOc1ccc(C(C)(C)c2ccc(OCCOC(=O)OCCC#C)cc2)cc1] |
| | BABC |
| | 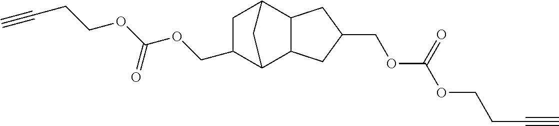 [SMILES: C#CCCOC(=O)OCC1CC2C3CC(COC(=O)OCCC#C)C(C3)C2C1] |
| | TCBC |

Variations and modifications may be made to the parts previously described without departing from the spirit or ambit of the disclosure.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method for fabricating a three-dimensional object layer-by-layer upon a work surface using two or more photocurable inks, the work surface configured to be moveable relative to an ink deposition arrangement and a light source, the method comprising forming a layer of the three-dimensional object, said forming of a layer comprising:
depositing a first photocurable ink;
selectively exposing the deposited first ink to the light source, to thereby cure at least a portion of the deposited first ink;
depositing a second photocurable ink; and
selectively exposing the deposited second ink to the light source, to thereby cure at least a portion of the deposited second ink;
wherein the cured portions of the first ink and the second ink form at least part of a layer of the three-dimensional object.

2. A method according to claim 1, wherein said portion of the deposited first ink is cured, prior to depositing the second ink.

3. A method according to claim 2, wherein, after curing the said portion of the first ink, a remaining uncured portion of the first ink is substantially removed, prior to depositing the second ink.

4. A method according to claim 1, wherein each of the first and the second inks are deposited, prior to curing of either the first or second inks.

5. A method according to claim 4, wherein, after curing the said portion of the second ink, a remaining uncured portion of the second ink is substantially removed.

6. A method according to any preceding claim, wherein the deposition arrangement is positioned at a first height above the work surface during deposition of the first ink, and wherein the deposition arrangement is positioned at a second height above the work surface during deposition of the second ink.

7. A method according to claim 6, wherein each of the first height and the second height are selected from a range of about 20 μm to about 1 mm.

8. A method according to claim 6 or claim 7, wherein the first height is approximately the same as the second height.

9. A method according to any preceding claim, wherein the ink deposition arrangement comprises two or more ink dispensers, each of the two or more ink dispensers configured for dispensing a respective ink.

10. A method according to claim 9, wherein each of the ink dispensers comprises one of a syringe or inkjet head.

11. A method according to claim 9 or claim 10, wherein, the forming of a layer of the three-dimensional object comprises moving the work surface relative to the ink deposition arrangement, the ink deposition arrangement selectively actuating one or more of the ink dispensers at different relative positions of the work surface and ink deposition arrangement, to thereby deposit the one or more inks at said positions.

12. A method according to any preceding claim, wherein the two or more photocurable inks each comprise a precursor of a material for forming a polymer, and forming said polymer comprises one or more of:
reacting a reactive thiol group of the ink with an ene compound of the ink, comprising one or more reactive ene groups, under conditions that promote a thiol-ene reaction;
reacting a reactive thiol group of the ink with an yne compound of the ink, comprising one or more reactive yne groups, under conditions that promote a thiol-yne reaction;
reacting a reactive thiol group of the ink with an acrylate compound of the ink, comprising one or more reactive acrylate groups, under conditions that promote a thiol-acrylate reaction.

13. A method according to any preceding claim, wherein the two or more photocurable inks each comprise one or more organosilicon-based monomers.

14. A method according to claim 13, wherein the one or more organosilicon-based monomers are selected from the group consisting of functionalised polysiloxanes, polycarbosiloxanes, polysilsesquioxanes, polycarbosilanes, polysilylcarbodiimides, polysilsesquicarbodiimides, polysilazanes, polysilsesquiazanes, polyborosilanes, polyborosiloxanes and polyborosilazanes.

15. A method according to any preceding claim, wherein one or more of the photocurable inks comprise ceramic particles.

16. A method according to any preceding claim, wherein one or more of the photocurable inks comprise one or more additives selected from the group consisting of a free-radical scavenger, a photoblocker and a photoinitiator.

17. A method according to any preceding claim, wherein the one or more inks have a viscosity in the range of about 0.1 Pa·s to 1000 Pa·s.

18. A method according to any preceding claim, wherein selectively exposing said deposited ink to said light source comprises generating a pattern of photocuring light, and projecting said pattern upon at least a portion of said deposited inks.

19. A method according any preceding claim, wherein exposure to said light source is carried out for an exposure time of between 1 millisecond to 1 hour.

20. A method according to any preceding claim, wherein the light source produces a photocuring light having a wavelength within the UV or visible spectrum.

21. A method according to claim 20, wherein the light source produces a photocuring light having a wavelength in the range of about 360 nm to about 420 nm.

22. A method for fabricating a three-dimensional object layer-by-layer upon a work surface using one or more photocurable inks, the work surface configured to be moveable relative to an ink deposition arrangement and a light source, the method comprising, for at least one layer of the three-dimensional object, forming said at least one layer such that said forming comprises:
depositing a photocurable ink to a first thickness, determined in a direction normal to a plane of the work surface; and
selectively exposing the deposited ink to the light source, to thereby cure at least a portion of the deposited first ink;
wherein the selective exposure of the deposited ink to the light source is configured such that said cured portion extends to a cured thickness, determined in a direction normal to a plane of the work surface, the cured thickness being less than or substantially equal to the deposited thickness.

23. A method according to claim 22, wherein a remaining uncured portion of the deposited ink is substantially removed, to thereby expose a surface of the cured portion.

24. A method according to claim 23, wherein a subsequent layer of the three-dimensional object is formed, so as to overlay at least a portion of said exposed surface.

25. A method according to any one of claims 22 to 24, wherein the forming of a layer of the three-dimensional object further comprises:
depositing a second photocurable ink to a second thickness, determined in a direction normal to a plane of the work surface; and
selectively exposing the deposited second ink to the light source, to thereby cure at least a portion of the deposited second ink;
wherein the cured portions of the first ink and the second ink form at least part of a layer of the three-dimensional object and wherein the selective exposure of the deposited second ink to the light source is configured such that said cured portion of the second ink extends to a cured thickness, determined in a direction normal to a plane of the work surface, the cured thickness of the second ink being less than or substantially equal to the deposited thickness of the second ink.

26. A method for fabricating a three-dimensional object layer-by-layer upon a work surface using one or more photocurable inks, the work surface configured to be moveable relative to an ink deposition arrangement and a light source, the method comprising forming a layer of the three-dimensional object, said forming of a layer comprising:
depositing photocurable ink; and
selectively exposing the deposited ink to the light source, to thereby cure at least a portion of the deposited ink;
the cured portion forming at least part of a layer of the three-dimensional object.

27. A method according to claim 26, wherein the photocurable ink has high oxygen resistivity.

28. A system for fabricating a three-dimensional object layer-by-layer using one or more photocurable inks, said system comprising:
a work surface upon which the three-dimensional object is fabricated;
an ink deposition arrangement configured for spatially controlled depositing of layers comprising one or more photocurable inks, each layer being in an initial ink deposition; and
a light source configured for selectively exposing each initial ink deposition to light so that at least part of said initial ink deposition is photocured to provide a consolidated layer of the three-dimensional object;
wherein the relative positioning of the work surface to the ink deposition arrangement and the light source is variable.

29. A system according to claim 28, wherein the system comprises an ink removal arrangement configured for removing at least a portion of an uncured part of said initial ink deposition.

30. A system according to claim 28, the system configured for performing the method of any one of claims 22 to 27.

31. A system according to claim 28 or claim 29, wherein the system is configured for fabricating the three-dimensional object using two or more photocurable inks, the cured portions of the two or more inks forming at least part of a layer of the three-dimensional object.

32. A system according to claim 31, wherein the system is configured for performing the method according to any one of claims 1 to 21.
